(19) United States
(12) Patent Application Publication
(10) Pub. No.: US 2026/0313321 A1
(43) Pub. Date: Oct. 8, 2026

(54) WIRELESS COMMUNICATION SYSTEM, WIRELESS COMMUNICATION METHOD, AND WIRELESS COMMUNICATION PROGRAM

(71) Applicant: DENSO CORPORATION, Kariya-city (JP)

(72) Inventors: Sho MATSUMOTO, Kariya-city (JP); Youichi HAYASE, Kariya-city (JP)

(73) Assignee: DENSO CORPORATION, Kariya-city (JP)

(21) Appl. No.: 19/630,761

(22) Filed: Mar. 27, 2026

Related U.S. Application Data
(63) Continuation of application No. PCT/JP2024/033003, filed on Sep. 16, 2024.

(30) Foreign Application Priority Data
Sep. 27, 2023 (JP) 2023-166448

(51) Int. Cl. H04W 4/08

(52) U.S. Cl. CPC H04W 4/08

(57) ABSTRACT

A plurality of secondary devices communicating wirelessly with a single primary device are grouped into two or more groups. A communication channel to be used for wireless communication is determined for each secondary device belonging to at least one group that is grouped, a common communication channel is extracted from the determined communication channel, and a common channel map is generated. A primary device and the secondary device grouped into at least one group perform wireless communication via the communication channel selected from the common communication channel indicated in the communication channel map.

### CROSS-REFERENCE TO RELATED APPLICATIONS

The present application is a continuation application of International Application No. PCT/JP2024/033003, filed on SEP 16, 2024, which claims priority to Japanese Patent Application No. 2023-166448, filed on SEP 27, 2023. The contents of these applications are incorporated herein by reference in their entirety.

### BACKGROUND

The present disclosure relates to a wireless communication system, a wireless communication method, and a wireless communication program.

A wireless communication system is known in which at least a single primary device and a plurality of secondary devices perform wireless communication via a single communication channel successively selected from a plurality of communication channels is known.

### SUMMARY

One aspect of the present disclosure provides a wireless communication system in which at least a single primary device and a plurality of secondary devices perform wireless communication via a single communication channel successively selected from a plurality of communication channels. The wireless communication system includes a grouping unit, a communication channel determination unit, and a generation unit. The grouping unit groups a plurality of the secondary devices communicating wirelessly with the single primary device into two or more groups. When the primary device communicates wirelessly with each of the plurality of secondary devices, the communication channel determination unit determines communication quality of each communication channel for secondary devices belonging to at least one group that is grouped by the grouping unit, and determines the communication channel to be used for wireless communication based on a determination result for the communication quality of each communication channel. The generation unit generates a common channel map by extracting a common communication channel that is a communication channel common to secondary devices belonging to the at least one group that is grouped by the grouping unit, based on the communication channel to be used for wireless communication determined by the communication channel determination unit for secondary devices belonging to the at least one group. The primary device and the secondary devices grouped into the at least one group are configured to perform wireless communication via the communication channel selected from the common communication channel indicated in the common channel map generated by the generation unit.

### BRIEF DESCRIPTION OF THE DRAWINGS

In the accompanying drawings:

FIG. 1 is a block diagram illustrating an overall configuration including a schematic configuration of a wireless communication system according to a first embodiment;

FIG. 2 is a diagram of an example of electric field strength distribution in a communication environment of a primary device and a secondary device;

FIG. 3 is a diagram of an example of reception signal strength of each communication channel;

FIG. 4 is a flowchart illustrating an example of a startup sequence between the primary device and the secondary device;

FIG. 5 is a flowchart illustrating an example of a communication sequence between the primary device and the secondary device;

FIG. 6 is a diagram illustrating an example of a list held by the primary device (or a control apparatus) in which identification information of a plurality of secondary devices and information on groups to which each secondary device belongs are associated;

FIG. 7 is a diagram illustrating an example of a relationship between communication events and sub-events when a number of secondary devices is two;

FIG. 8 is a flowchart illustrating an example of a channel map generation process in the flowchart in FIG. 5;

FIG. 9 is a table illustrating an example in which a common channel map is generated for all secondary devices in a case in which the primary device communicates with a total of nine secondary devices;

FIG. 10 is a table illustrating an example in which the total of nine secondary devices are grouped into three groups and a common channel map is generated for each group;

FIG. 11 is a flowchart illustrating an example of a communication sequence in a wireless communication system according to a second embodiment;

FIG. 12 is an explanatory diagram for explaining a grouping method of a wireless communication system according to a third embodiment;

FIG. 13 is a diagram illustrating an example in which a plurality of secondary devices are grouped based on the grouping method of the wireless communication system according to the third embodiment;

FIG. 14 is a diagram illustrating another example in which the plurality of secondary devices are grouped based on the grouping method of the wireless communication system according to the third embodiment;

FIG. 15 is a diagram illustrating an example in which a plurality of secondary devices are grouped based on a grouping method of a wireless communication system according to a fourth embodiment;

FIG. 16 is a diagram illustrating an example in which a plurality of secondary devices are grouped based on a grouping method of a wireless communication system according to a fifth embodiment;

FIG. 17 is a diagram illustrating another example in which the plurality of secondary devices are grouped based on the grouping method of the wireless communication system according to the fifth embodiment;

FIG. 18 is a diagram illustrating a variation example of the wireless communication system according to the fifth embodiment;

FIG. 19 is a diagram illustrating another variation example of the wireless communication system according to the fifth embodiment;

FIG. 20 is a diagram illustrating still another variation example of the wireless communication system according to the fifth embodiment; and

FIG. 21 is a flowchart illustrating the grouping method of the wireless communication system according to the sixth embodiment.

### DESCRIPTION OF THE EMBODIMENTS

The present disclosure relates to a wireless communication system in which at least a single primary device and a plurality of secondary devices perform wireless communication via a single communication channel successively selected from a plurality of communication channels, a wireless communication method, and a wireless communication program.

As this type of wireless communication system, for example, a wireless communication system described in JP 2006-128812 A is known. In the wireless communication system in JP 2006-128812 A, in a case in which a packet error occurs in a reception signal of a wireless communication apparatus, if a received signal strength indicator (RSSI) value of a wireless signal of the packet is greater than a threshold Th1 set in advance, the wireless communication apparatus determines that a reception operation by which this packet is received is a reception error due to interference with other radio waves. Then, the wireless communication apparatus counts a number of receptions and a number of reception errors, and stores frequency of reception errors (number of reception errors / number of receptions) due to interference of each frequency channel. If the frequency of reception errors exceeds a threshold Th2, the wireless communication apparatus determines that an interference source is present in the frequency channel of which the frequency of reception errors due to interference exceeds the threshold Th2, and stores this frequency channel as an unusable channel.

As described above, the wireless communication system in JP 2006-128812 A sets a frequency channel of which communication quality has decreased due to interference with other radio waves as an unusable channel. In addition, the wireless communication system in JP 2006-128812 A restores a frequency channel that has been set to the unusable channel to a usable channel upon elapse of a predetermined preset period. In the present specification, generating a channel map that indicates the usable channel through control in which a frequency channel is set to the unusable channel and restored to the usable channel in this manner is referred to hereafter as channel map control.

Here, when the primary device performs wireless communication with a plurality of secondary devices, a common communication channel being extracted from frequency channels (communication channels) usable by each secondary device, and a channel map common among the secondary devices being generated can be considered. A reason for this is that, as a result of such a common channel map being generated, various types of processes related to the channel map, such as update, storage, and transmission of the channel map, required for wireless communication with each of the plurality of secondary devices can be facilitated. However, if the common channel map is simply generated for the plurality of secondary devices with which the primary device performs wireless communication, securing a sufficient number of communication channels usable for wireless communication may be difficult, such as in a case in which a number of communication channels common among the secondary devices is small.

It is thus desired to provide a wireless communication system capable of suppressing occurrence of a situation in which a sufficient number of communication channels is unable to be secured, while using a common channel map for a plurality of secondary devices, a wireless communication method, and a wireless communication program.

A first exemplary embodiment of the present disclosure provides a wireless communication system in which at least a single primary device) and a plurality of secondary devices perform wireless communication via a single communication channel successively selected from a plurality of communication channels, the wireless communication system including: a grouping unit that groups a plurality of the secondary devices communicating wirelessly with the single primary device into two or more groups; a communication channel determination unit that, when the primary device communicates wirelessly with each of the plurality of secondary devices, determines communication quality of each communication channel for secondary devices belonging to at least one group that is grouped by the grouping unit, and determines the communication channel to be used for wireless communication based on a determination result for the communication quality of each communication channel; and a generation unit that generates a common channel map by extracting a common communication channel that is a communication channel common to secondary devices belonging to the at least one group that is grouped by the grouping unit, based on the communication channel to be used for wireless communication determined by the communication channel determination unit for secondary devices belonging to the at least one group, in which the primary device and the secondary devices grouped into the at least one group are configured to perform wireless communication via the communication channel selected from the common communication channel indicated in the common channel map generated by the generation unit.

A second exemplary embodiment of the present disclosure provides a wireless communication method by which at least a single primary device and a plurality of secondary devices perform wireless communication via a single communication channel successively selected from a plurality of communication channels, the wireless communication method including: grouping a plurality of the secondary devices communicating wirelessly with the single primary device into two or more groups; determining, when the primary device communicates wirelessly with each of the plurality of secondary devices, communication quality of each communication channel for secondary devices belonging to at least one group that is grouped, and determining the communication channel to be used for wireless communication based on a determination result for the communication quality of each communication channel; and generating a common channel map by extracting a common communication channel that is a communication channel common to secondary devices belonging to the at least one group that is grouped, based on the communication channel to be used for wireless communication determined for secondary devices belonging to the at least one group, in which the primary device and the secondary devices grouped into the at least one group are configured to perform wireless communication via the communication channel selected from the common communication channel indicated in the generated common channel map.

A third exemplary embodiment of the present disclosure provides a wireless communication program by which at least a single primary device and a plurality of secondary devices perform wireless communication via a single communication channel successively selected from a plurality of communication channels, the wireless communication program causing at least a single processor to perform: grouping a plurality of the secondary devices communicating wirelessly with the single primary device into two or more groups; determining, when the primary device communicates wirelessly with each of the plurality of secondary devices, communication quality of each communication channel for secondary devices belonging to at least one group that is grouped, and determining the communication channel to be used for wireless communication based on a determination result for the communication quality of each communication channel; and generating a common channel map by extracting a common communication channel that is a communication channel common to secondary devices belonging to the at least one group that is grouped, based on the communication channel to be used for wireless communication determined for secondary devices belonging to the at least one group, in which the primary device and the secondary devices grouped into the at least one group are configured to perform wireless communication via the communication channel selected from the common communication channel indicated in the generated common channel map.

As described above, in the wireless communication system, the wireless communication method, and the wireless communication program of the present disclosure, the plurality of secondary devices communicating wirelessly with the single primary device are grouped into two or more groups. Then, the communication channel to be used for wireless communication is determined for secondary devices belonging to at least one group that is grouped, the common communication channel is extracted from the determined communication channel, and the common channel map is generated. In this manner, as a result of the wireless communication system, the wireless communication method, and the wireless communication program of the present disclosure, the common channel map is generated for secondary devices belonging to at least one group that is grouped upon the plurality of secondary devices communicating wirelessly with the single primary device being grouped into two or more groups, rather than the common channel map being simply generated for all secondary devices communicating wirelessly with the single primary device. Therefore, occurrence of a situation in which a sufficient number of communication channels is unable to be secured can be suppressed while the common channel map is used for the plurality of secondary devices.

Reference numbers within parentheses in the scope of claims merely indicate examples of corresponding relationships with specific configurations according to the embodiments described hereafter to facilitate understanding of the present disclosure, and are not intended to limit the scope of the present disclosure in any way.

Preferred embodiments of the present disclosure will hereinafter be described with reference to the drawings. Here, regarding identical or similar configurations, descriptions may be omitted by same reference numbers being given across a plurality of drawings. In cases in which only a portion of a configuration according to an embodiment is described, a configuration according to another embodiment described earlier can be applied to other portions of the configuration. Furthermore, in addition to combinations of configurations clearly indicated in the descriptions according to the embodiments, configurations according to a plurality of embodiments may be combined in part without this being clearly indicated, as long as no conflict arises from the combination.

### First embodiment

A wireless communication system according to a present embodiment includes at least a single primary device and a plurality of secondary devices. At least either of the primary device and the secondary device may be used mounted on a moving body. For example, the moving body includes vehicles such as automobiles and railway cars, flight vehicles such as electric vertical takeoff and landing aircrafts and drones, ships, construction machinery, and agricultural machinery.

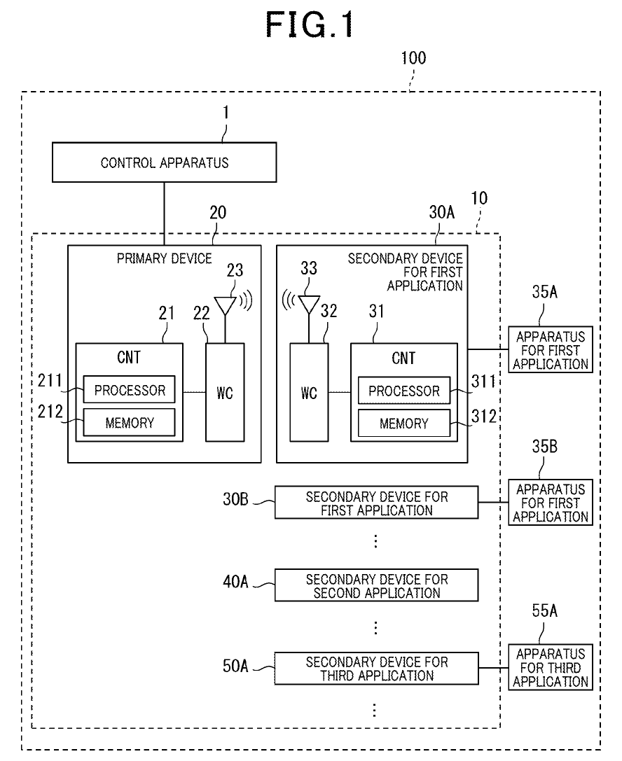

FIG. 1 shows an example of a configuration in a case in which a wireless communication system 10 according to the present embodiment is applied to a vehicle 100. As a specific application in the vehicle 100, the wireless communication system 10 according to the present embodiment is capable of being applied to a plurality of vehicle systems (vehicle applications) of various types. In this case, to perform wireless communication with a primary device 20 for execution of any of the plurality of vehicle applications, each of a plurality of secondary devices 30A, 30B, 40A, and 50A is associated with any of the vehicle applications.

For example, as one of the vehicle applications, the wireless communication system 10 is capable of being applied to a battery management system that manages a battery mounted as a battery pack in an electric vehicle, such as an electric car, a hybrid car, or a plug-in hybrid car. In the case in which the wireless communication system 10 is applied to the battery management system, for example, at least a single primary device 20 is connected to a control apparatus 1 that provides a function as a battery control apparatus. The plurality of secondary devices 30A and 30B are connected to apparatuses 35A and 35B for first application that provide a function as monitoring apparatuses respectively provided in a plurality of battery stacks configuring the battery pack. In this case, the primary device 20 and the secondary devices 30A and 30B are both mounted in the vehicle.

The monitoring apparatuses (apparatuses 35A and 35B for first application) provided in respective battery stacks acquire battery information, such as a voltage and a current of each battery cell included in the corresponding battery stack and a temperature of the battery stack, from various sensors and the like. Then, upon receiving data requesting the battery information from the battery control apparatus (control apparatus 1) through the wireless communication system 10, the monitoring apparatuses (apparatuses 35A and 35B for first application) transmit the acquired battery information to the battery control apparatus (control apparatus 1) through the wireless communication system 10. The battery control apparatus (control apparatus 1) calculates an amount of charge (state of charge [SOC]) of the overall battery stack, drives a temperature raising and cooling mechanism to adjust the temperature of the battery pack to an appropriate range, determines whether execution of a so-called equalization process to align the voltages of the battery cells in the battery stack is necessary, and the like based on the acquired battery information. When determined that the execution of the equalization process is necessary in at least one battery stack, the battery control apparatus (control apparatus 1) instructs the corresponding monitoring apparatus (apparatuses 35A and 35B for first application) to perform the equalization process through the wireless communication system 10. In addition, the monitoring apparatuses (apparatuses 35A and 35B for first application) perform a process to determine abnormalities in various sensors and abnormalities in its own operations. When an abnormality is determined, the monitoring apparatus (apparatuses 35A and 35B for first application) transmits abnormality information to the battery control apparatus (control apparatus 1) through the wireless communication system 10.

Furthermore, as other vehicle applications, the wireless communication system 10 according to the present embodiment is capable of being applied to a smart key system (registered trademark; similarly applies hereafter) supporting a so-called digital key and a tire air-pressure monitoring system. In the case in which the wireless communication system 10 is applied to the smart key system that supports a digital key, for example, the primary device 20 is mounted in a vehicle and connected to the control apparatus 1 that provides a function as a vehicle control apparatus that controls locking and unlocking of vehicle doors, and on and off of a drive source such as an engine of the vehicle. In addition to being mounted in a mobile device (such as a smartphone or a smartwatch) used as a digital key or an electronic key (neither of which are shown), the plurality of secondary devices are disposed in locations such as a front portion, a side portion, a rear portion, and the like of the vehicle to detect a position of the digital key or the electronic key relative to the vehicle 100. For example, the plurality of secondary devices 40A disposed in the locations on the vehicle functions to intercept communication between the primary device 20 and the secondary device mounted in the digital key or the electronic key, and transmits an intercepted communication result to the primary device 20. As a result, the primary device 20 (or the control apparatus 1) is capable of detecting the position of the digital key or the electronic key using a position identification technology such as trilateration or traverse surveying, based on a position of each secondary device 40A, a time at which each secondary device 40A intercepts the communication, and/or an angle of arrival of a communication signal at each secondary device 40A.

In the case in which the wireless communication system 10 is applied to the tire air-pressure monitoring system, the primary device 20 is mounted in the vehicle and connected to the control apparatus 1 that provides a function as an air-pressure monitoring control apparatus that displays tire air-pressure, issues a warning when the air pressure is abnormal, and the like. A plurality of secondary devices 50A are connected by wire or wirelessly to an air-pressure detection apparatus (third application apparatus 55A) provided inside each tire. Then, the air pressure detected by the air-pressure detection apparatus (third application apparatus 55A) is transmitted to the air-pressure monitoring control apparatus (control apparatus 1) through the wireless communication system 10. The air-pressure monitoring control apparatus (control apparatus 1) displays the tire air-pressure, issues a warning when the air pressure is abnormal, and the like based on the received air pressure.

Moreover, the wireless communication system 10 according to the present embodiment may be applied to a diagnostic system of the vehicle instead of one of the plurality of vehicle applications described above or in addition to the plurality of vehicle applications. In this case, for example, a plurality of secondary devices are connected to a plurality of in-vehicle apparatuses (application apparatuses) provided with a self-diagnosis function, and the primary device is connected to a diagnostic control apparatus set in a service factory. In this example, the plurality of secondary devices are mounted in the vehicle 100.

However, application examples of the wireless communication system 10 according to the present embodiment are not limited to the vehicle applications. As described above, the wireless communication system 10 is also capable of being applied to a system (application) for controlling and managing moving bodies other than the vehicle, for example, various equipment such as flight vehicles such as drones, ships, construction machinery, and agricultural machinery. Furthermore, the wireless communication system 10 according to the present embodiment is also capable of being applied to a system for controlling and managing various equipment in structures such as buildings and production equipment in factories, and the like.

According to the embodiments described hereafter, examples of a case in which the wireless communication system 10 is applied to the battery management system, the smart key system, and the air-pressure monitoring system as a plurality of vehicle applications will be described. In this case, as shown in FIG. 1, the primary device 20 and the secondary devices 30A, 30B, 40A, and 50A of the wireless communication system 10 are both mounted in the vehicle (automobile) 100. A single primary device 20 or a plurality thereof may be provided. In the case in which a plurality of primary devices 20 are provided, each of the plurality of primary devices 20 may communicate with the plurality of secondary devices 30A, 30B, 40A, and 50A belonging to differing groups. Alternatively, the plurality of primary devices 20 may communicate with the plurality of secondary devices 30A, 30B, 40A, and 50A belonging to a same group. The primary device 20 and the secondary devices 30A, 30B, 40A, and 50A perform wireless communication via a single communication channel successively selected from a plurality of communication channels, such as by Bluetooth Low Energy (Bluetooth is a registered trademark and similarly applies hereafter; Bluetooth Low Energy is referred to hereafter as Bluetooth LE) communication.

In the wireless communication between the primary device 20 and the secondary devices 30A, 30B, 40A, and 50A, a frequency band used in short-range communication such as a 2.4GHz band or a 5GHz band is capable of being used. Radio waves in high-frequency bands such as these have properties of having stronger linearity than radio waves in LF bands and being more easily reflected by metal bodies such as a body of a vehicle. LF is an abbreviation for low frequency. For example, Bluetooth and Bluetooth LE can be used as standards for short-range communication. As an example, the primary device 20 and the secondary devices 30A, 30B, 40A, and 50A according to the present embodiment are configured to be capable of performing wireless communication (referred to hereafter as Bluetooth LE communication) compliant with the Bluetooth LE standard. Details of communication methods relating to communication connections, cryptographic communication, and the like are implemented based on a sequence specified in the Bluetooth LE standard.

As shown in FIG. 1, the primary device 20 includes a control circuit (CNT) 21, a wireless communication circuit (WC) 22, and an antenna 23. In addition to the above-mentioned elements, the primary device 20 may include an input/output interface to communicate by wire or wirelessly with an apparatus other than the secondary devices 30A, 30B, 40A, and 50A, and a bus line. Here, processes such as a channel map control process, a channel map generation process, and a channel map sharing process, described hereafter, may be performed by the control circuit 21. Alternatively, some or all of the processes may be performed by another control apparatus (such as the control apparatus 1) provided outside the primary device 20.

For example, the control circuit 21 is a computer that includes a processor 211 and a memory 212. For example, the memory 212 includes a RAM or a ROM. RAM is an abbreviation for random access memory. ROM is an abbreviation for read-only memory.

In the control circuit 21, the processor 211 performs a predetermined process (control) by executing a program stored in the ROM while using the RAM as a temporary storage area. The processor 211 constructs a plurality of functional units by executing a plurality of commands included in the program. A plurality of processors 211 may be provided. A storage medium for the program is not limited to the ROM. For example, a variety of storage media such as an HDD and an SSD can be used. HDD is an abbreviation for hard-disk drive. SSD is an abbreviation for solid state drive.

For example, the processor 211 is a CPU, an MPU, a GPU, or a DFP. CPU is an abbreviation for central processing unit. MPU is an abbreviation for micro-processing unit. GPU is an abbreviation for graphics processing unit. DFP is an abbreviation for data flow processor. The control circuit 21 may be actualized by combining a plurality of types of arithmetic processing apparatuses, such as a CPU, an MPU, and a GPU. Alternatively, the control circuit 21 may be actualized as an SoC. SoC is an abbreviation for System on Chip. The control circuit 21 may be actualized using ASIC or FPGA. ASIC is an abbreviation for application specific integrated circuit. FPGA is an abbreviation for field-programmable gate array.

The control circuit 21 generates a command to request processing from the secondary devices 30A, 30B, 40A, and 50A (such as a command to request data or a command to request execution of a predetermined process), and transmits transmission data including the command to the wireless communication circuit 22 by a transmission packet. In addition, the control circuit 21 receives packets transmitted from the secondary devices 30A, 30B, 40A, and 50A through the wireless communication circuit 22, and performs predetermined processes based on the data included in the received packets. That is, wireless communication performed by the primary device 20 and the secondary devices 30A, 30B, 40A, and 50A is packet communication.

The wireless communication circuit 22 includes an RF circuit (not shown) for wirelessly transmitting and receiving packets. The wireless communication circuit 22 provides a transmission function for modulating a transmission signal and oscillating at a frequency of an RF signal. In addition, the wireless communication circuit 22 provides a reception function for demodulating a reception signal. RF is an abbreviation for radio frequency.

The wireless communication circuit 22 modulates the packet including data transmitted from the control circuit 21 and transmits the packet to the secondary devices 30A, 30B, 40A, and 50A via the antenna 23. For example, the control circuit 21 outputs data that is the transmission data encrypted using encryption information exchanged in a connection establishment process, described hereafter, to the wireless communication circuit 22. The wireless communication circuit 22 attaches data necessary for wireless communication (such as communication control information) to the transmission packet and transmits the transmission packet. The data necessary for wireless communication includes, for example, an identifier (ID), a sequence number, a next sequence number, and an error detection code. The wireless communication circuit 22 may control data size, communication format, schedule, error detection, and the like of the communication between the primary device 20 and the secondary devices 30A, 30B, 40A, and 50A. These types of control related to communication may be performed by the control circuit 21.

The wireless communication circuit 22 receives the packets transmitted from the secondary devices 30A, 30B, 40A, and 50A via the antenna 23, and demodulates the packets. Then, the demodulated packets are transmitted to the control circuit 21. The antenna 23 converts an electrical signal to a radio wave and radiates the radio wave into space. The antenna 23 receives a radio wave propagated through space and converts the radio wave to an electrical signal.

The secondary devices 30A, 30B, 40A, and 50A each have the same configuration. Configurations, workings, and the like will be described below using the secondary device 30A as a typical example. However, the plurality of secondary devices 30A, 30B, 40A, and 50A may be mentioned as required.

As shown in FIG. 1, the secondary device 30A includes a control circuit (CNT) 31, a wireless communication circuit (WC) 32, and an antenna 33. In addition to the above-described elements, the secondary device 30A includes an input/output interface to communicate by wire or wirelessly with an apparatus other than the primary device 20, and a bus line. The control circuit 31 has a configuration similar to that of the control circuit 21 of the primary device 20. For example, the control circuit 31 may include a processor 311 and a memory 312. For example, the memory 312 may include a RAM and a ROM.

The control circuit 31 performs a requested process (such as a response process to acquire and return requested data, and an execution process for a requested process) based on a request command acquired through the wireless communication circuit 32. For example, in a case in which the request command included in the received data is a transmission request for battery information, the control circuit 31 of the secondary device 30A transmits the transmission request to the monitoring apparatus (such as the apparatus 35A for first application) of the corresponding battery stack and acquires the battery information from the monitoring apparatus (such as the apparatus 35A for first application). Then, in response to the request, the control circuit 31 transmits data that includes a processing result (such as the acquired battery information) and is encrypted using encryption information to the wireless communication circuit 32. In addition, the control circuit 31 is also capable of performing control of apparatuses mounted in the vehicle, for example, based on the requested process.

The wireless communication circuit 32 includes an RF circuit (not shown) for wirelessly transmitting and receiving packets. In a manner similar to the wireless communication circuit 22, the wireless communication circuit 32 provides a transmission function and a reception function. The wireless communication circuit 32 receives a packet transmitted from the primary device 20 via the antenna 33, and demodulates the packet. Then, the data included in the demodulated packet is transmitted to the control circuit 31. The wireless communication circuit 32 modulates a packet including data transmitted from the control circuit 31 and transmits the packet to the primary device 20 via the antenna 33. The wireless communication circuit 32 attaches data necessary for wireless communication, such as communication control information, to the transmission packet and transmits the transmission packet.

The wireless communication circuit 32 may control data size, communication format, schedule, error detection, and the like of the communication between the primary device 20 and the secondary device 30A. These types of control related to communication may be performed by the control circuit 31. The antenna 33 converts an electrical signal to a radio wave and radiate the radio wave into space. The antenna 33 receives a radio wave propagated through space and converts the radio wave to an electrical signal.

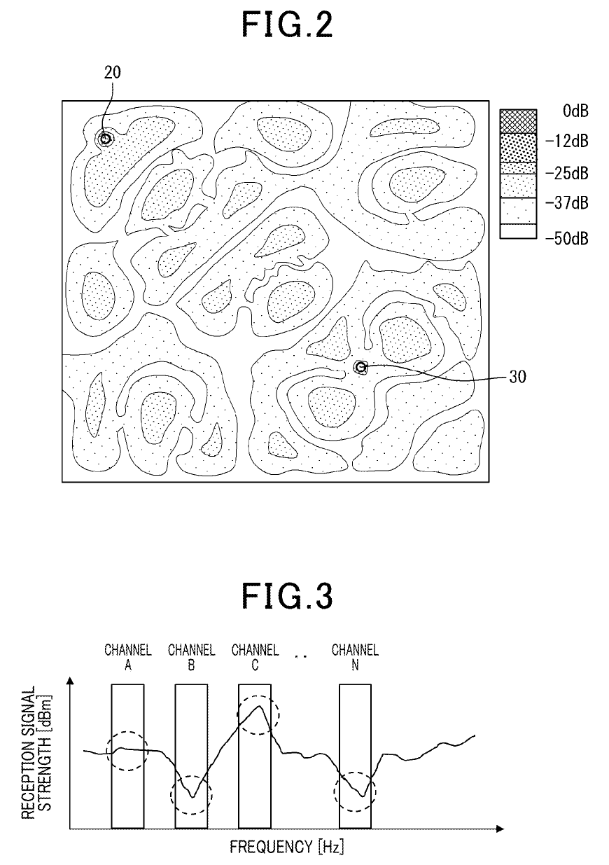

FIG. 2 is a diagram showing an example of an electric field strength distribution in a communication environment of the primary device 20 and the secondary device 30A. FIG. 2 shows an electromagnetic field simulation result at a predetermined timing at a predetermined frequency. The electric field strength distribution may be referred to hereafter as an electric field distribution.

For example, the primary device 20 and the secondary device 30A are disposed in predetermined positions in the vehicle. When wireless radio wave signals of a predetermined frequency are transmitted from the primary device 20 and the secondary device 30A respectively disposed in the predetermined positions, a section having high electric field strength and a section having low electric field strength are formed in a usage environment due to interference between transmission waves and reflected wave, and interference with external noise. The reflected wave is generated by reflection by metal elements of the vehicle present around the primary device 20 and the secondary device 30A, such as reflection by a vehicle body, reflection by a metal housing, or reflection by a harness. For reasons such as this, in the communication environment of the primary device 20 and the secondary device 30A, a plurality of sections having high electric field strength and so-called NULL points that are sections having low electric field strength are formed.

If the secondary device 30A is positioned in or near the section having low electric field strength in the electric field distribution with the primary device 20, a likelihood of the secondary device 30A being unable to correctly receive a wireless signal from the primary device 20 is high, and communication error may occur. A communication channel in which such a communication error is likely to occur is a communication channel of which communication quality is decreased.

Here, when the primary device 20 and the secondary device 30A perform wireless communication via a single communication channel that is successively selected from a plurality of communication channels, because the frequency of each communication channel differs, the electric field distributions of the communication channel may also change. As a result, communication quality may differ among the communication channels.

For example, as shown in FIG. 3, in wireless communication via a communication channel A, reception power (reception signal strength) serving as one among parameters indicating the communication quality is good. In addition, in wireless communication via a communication channel C, the reception power indicates a very high value. Therefore, when the primary device 20 and the secondary device 30A use the communication channels A and C of which the communication quality is good or very high, high-quality wireless communication in which communication errors are sufficiently suppressed may be performed. Meanwhile, in wireless communication via communication channels B and N, the reception power is low. Therefore, when the primary device 20 and the secondary device 30A use the communication channels B and N of which the communication quality is decreased, a likelihood of a communication error occurring in the wireless communication increases. Here, in FIG. 3, an example of the reception signal strength relative to frequency is shown by a solid line to facilitate understanding.

Therefore, wireless communication between the primary device 20 and the secondary device 30A is preferably performed using a communication channel through which high-quality wireless communication can be performed, and avoiding a communication channel of which the communication quality is decreased.

However, the electric field distribution between the primary device 20 and the secondary device 30A changes depending on an external environment (such as external noise) and vibrations of the primary device 20 and/or the secondary device 30A (including vibrations of the metal housing and the harness). Therefore, when the primary device 20 and the secondary device 30A are mounted in the vehicle, the electric field distribution in the communication environment of the primary device 20 and the secondary device 30A changes based on, for example, a state of the vehicle (such as traveling or stopped) and a state of a surrounding environment of the vehicle (such as high or low external noise). As a result, the communication channel of which the communication quality is good and the communication channel of which the communication quality is decreased are not fixed and may change from moment to moment. Therefore, it is desired that the communication quality of each communication channel be continuously monitored so that, in response to decrease in communication quality, the corresponding communication channel is removed from the plurality of communication channels to be used for wireless communication, and in response to recovery of communication quality, the corresponding communication channel is restored as one of the plurality of communication channels to be used for wireless communication.

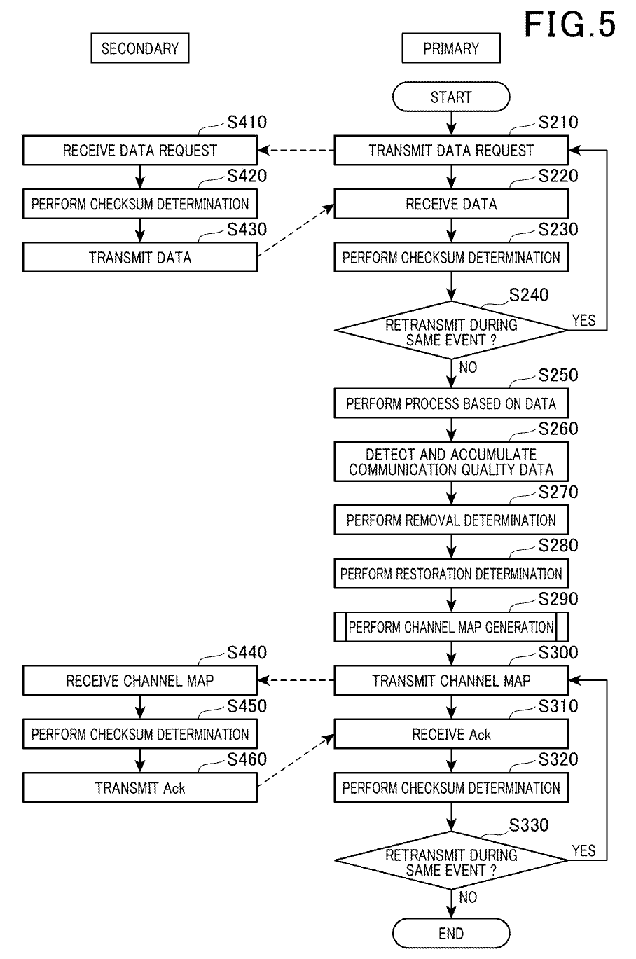

In the wireless communication system 10 according to the present embodiment, a control process for actualizing wireless communication between the primary device 20 and the secondary device 30A by removing the communication channel of which the communication quality is decreased by channel map control and using the communication channels of which a certain degree of communication quality is secured as the plurality of communication channels to be used for wireless communication is described with reference to a diagram showing a communication sequence between the primary device 20 and the secondary device 30A shown in FIG. 5. In FIG. 5, the primary device 20 is denoted as PRIMARY and the secondary device 30A is denoted as SECONDARY. Here, FIG. 5 shows a communication sequence performed between the primary device 20 and the secondary device 30A. The primary device 20 individually performs the communication sequence shown in FIG. 5 with the plurality of secondary devices 30A, 30B, 40A, and 50A. However, the primary device 20 may also simultaneously perform data transmissions to the plurality of secondary devices 30A, 30B, 40A, and 50A by group. The groups will be described in detail hereafter.

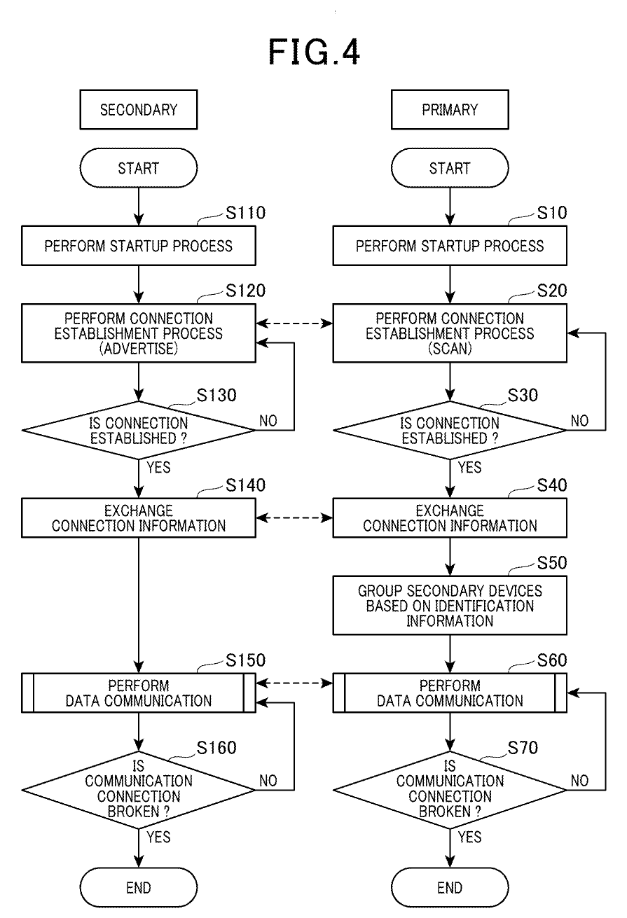

Here, the primary device 20 and the secondary device 30A perform the connection establishment process before performing the communication sequence shown in FIG. 5. In FIG. 4, an example of a startup sequence including the connection establishment process performed from when the primary device 20 and the secondary device 30A are started until when data communication is performed is shown. Here, the primary device 20 also individually performs this connection establishment process with the plurality of secondary devices 30A, 30B, 40A, and 50A.

For example, when the wireless communication system 10 is mounted in the vehicle, the startup sequence is started when an IG signal is switched from off to on by user operation. Here, when the primary device 20 and the secondary device 30A are connected at all times, the start-up sequence is executed only once at a predetermined timing. However, in a case in which an error occurs during communication and the wireless communication connection between the primary device 20 and the secondary device 30A is broken, the start-up sequence may be performed for reconnection.

When the start-up sequence is started, the primary device 20 and the secondary device 30A perform the start-up process including a reset process to reset various types of variables, timers, and the like, at steps S10 and S110, respectively. Then, the primary device 20 and the secondary device 30A perform the connection establishment process at steps S20 and S120, respectively. In the connection establishment process, for example, the secondary device 30A performs an advertising operation for transmitting an advertising signal via an advertising communication channel, and the primary device 20 performs a scanning operation for scanning the advertising signal. The advertising communication channel includes a plurality of communication channels (such as three for Bluetooth LE). When the primary device 20 receives an advertising signal on any of the communication channels by the scanning operation, the primary device 20 sends a connection request to the secondary device 30A transmitting the advertising signal. As a result, a communication connection is established between the primary device 20 and the secondary device 30A. When the primary device 20 and the secondary device 30A determine that the communication connection is established at steps S30 and S130, respectively, the primary device 20 proceeds to step S40 and the secondary device 30A proceeds to step S140.

The primary device 20 and the secondary device 30A perform an exchange of connection information at steps S40 and S140, respectively. In this exchange of connection information, the primary device 20 and the secondary device 30A exchange the encryption information used in data communication and perform a sharing process for initial information relating to frequency channel hopping. For example, the initial information includes an initial channel map, a hopping pattern, or a function for hopping. In addition, in the exchange of connection information, the primary device 20 acquires identification information for identifying each of the secondary devices 30A, 30B, 40A, and 50A from the secondary device 30A. This identification information may be the identifier included in the communication control information, or identification information differing from the identifier included in the communication control information.

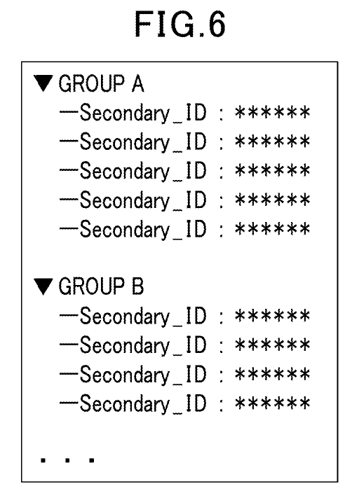

The primary device 20 (or control apparatus 1) holds a list associating the identification information of each of the plurality of secondary devices 30A, 30B, 40A, and 50A and information on groups to which each of the plurality of secondary devices 30A, 30B, 40A, 50A belongs. FIG. 6 shows an example of the list associating the identification information of the plurality of secondary devices 30A, 30B, 40A, and 50A and the information on the groups to which each of the secondary devices 30A, 30B, 40A, and 50A belongs, held by the primary device 20 (or the control apparatus 1). As shown in FIG. 6, the identification information of the secondary devices 30A, 30B, 40A, and 50A belonging to each group is listed in the list for each group.

According to the present embodiment, the groups correspond to the vehicle applications. As described above, to perform wireless communication with the primary device 20 for execution of any of the plurality of vehicle applications, each of the plurality of secondary devices 30A, 30B, 40A, and 50A is associated with any of the vehicle applications. Therefore, according to the present embodiment, a list is prescribed so that each of the plurality of secondary devices 30A, 30B, 40A, and 50A belongs to groups defined for corresponding applications. At step S50, the primary device 20 (or the control apparatus 1) references the list and groups the secondary device 30A based on the identification information transmitted wirelessly from the secondary device 30A to the primary device 20.

Alternatively, each of the plurality of secondary devices 30A, 30B, 40A, and 50A may be configured to hold the identification information for identifying the each of the secondary devices 30A, 30B, 40A, and 50A and group information indicating the respective groups to which the secondary devices 30A, 30B, 40A, and 50A belong. In this case, each of the plurality of secondary devices 30A, 30B, 40A, and 50A transmits the held identification information and group information to the primary device 20 during the exchange of connection information in the startup sequence with the primary device 20. The primary device 20 is capable of acquiring information similar to the above-described list from the identification information and the group information transmitted from each of the plurality of secondary devices 30A, 30B, 40A, and 50A. Therefore, the primary device 20 (or control apparatus 1) is capable of grouping the secondary devices 30A, 30B, 40A, and 50A based on the received identification information and group information.

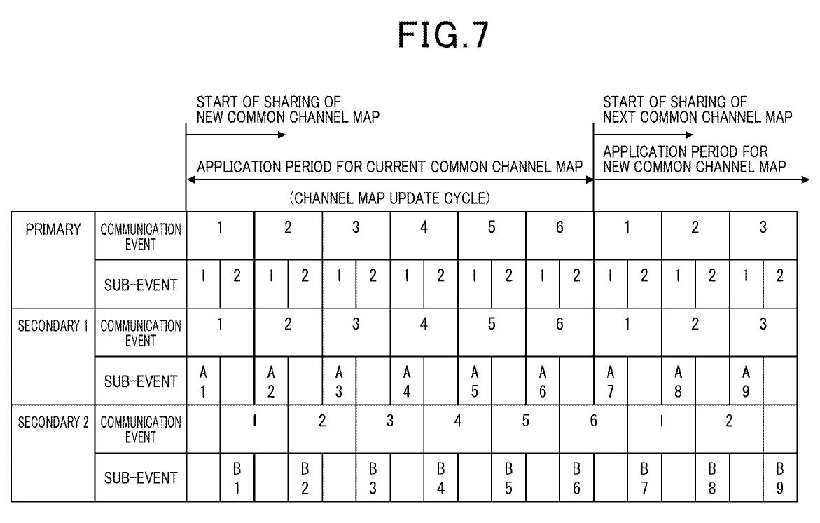

Then, the primary device 20 and the secondary device 30A perform data communication via a data communication channel successively selected by channel hopping from a plurality of communication channels usable for communication indicated by the channel map, for every communication event occurring periodically, at steps S60 and S150, respectively. A process for performing this data communication is shown in a communication sequence in FIG. 5. Here, the primary device 20 communicates with the plurality of secondary devices 30A, 30B, 40A, and 50A in turn by assigning the plurality of secondary devices 30A, 30B, 40A, and 50A respective communication periods (sub-events) in each communication event. A time chart in FIG. 7 shows an example of a relationship between communication events and sub-events when the number of secondary devices is two. For example, in the example shown in the time chart in FIG. 7, the primary device (Primary) is capable of mutually performing transmission and reception of data with the secondary device 1 (Secondary 1) during a period of sub-event 1, and mutually performing transmission and reception of data with the secondary device 2 (Secondary 2) during a period of sub-event 2 in each communication event. Alternatively, for example, the primary device can simultaneously perform data transmission to both of the secondary device 1 and the secondary device 2 during the period of sub-event 1 in each communication event, and respective data transmission from the secondary device 1 and the secondary device 2 can be performed during the periods of sub-event 1 and sub-event 2, respectively.

When the primary device 20 and the secondary device 30A determine that the communication connection is to be broken at steps S70 and S160, respectively, the start-up sequence shown in FIG. 4 is ended. For example, when the wireless communication system 10 is mounted in the vehicle, the primary device 20 and the secondary device 30A may determine that the communication connection is to be broken when the IG signal switches from on to off by user operation. In addition, the primary device 20 and the secondary device 30A may determine that the communication connection is to be broken when, for example, data communication cannot be performed in a normal manner for a predetermined consecutive number of times.

Next, the communication sequence for data communication will be described with reference to the flowchart in FIG. 5. As shown in FIG. 5, at step S210, the primary device 20 transmits, for example, a request command for data, that is, a data request to the secondary device 30A. However, in addition to the data request, the primary device 20 is also capable of transmitting a request to perform a predetermined process, for example. Upon receiving the data request at step S410, at step S420, the secondary device 30A performs, for example, checksum determination based on an error detection code included in the received data request to confirm whether the data request is correctly received. When determined that the data request is not correctly received based on a checksum determination result of the process at step S420, for example, at step S430, the secondary device 30A transmits a signal indicating that the data request is not correctly received or a signal requesting retransmission of the data request. Meanwhile, when determined that the data request is correctly received in the process at step S420, at step S430, the secondary device 30A performs a predetermined process necessary for issuing a response, such as a process to acquire and transmit the requested data.

Here, the primary device 20 and the secondary device 30A perform the transmission and reception of the data request and the transmission and reception of the requested data by switching the data communication channel to be used by frequency channel hopping for each communication event. At this time, the primary device 20 and the secondary device 30A determine the communication channel to be switched by frequency channel hopping based on the channel map held by each of the primary device 20 and the secondary device 30A. For example, in the case of Bluetooth LE communication, 37 communication channels are provided as data communication channels.

At step S220, the primary device 20 receives the requested data. Then, at step S230, the primary device 20 performs, for example, the checksum determination based on the error detection code included in the received data to confirm whether the data is correctly received. At following step S240, the primary device 20 determines whether to perform a process for retransmission during a same communication event when determined that the data is not correctly received in the process at step S230 or when a signal indicating that the data request is not correctly received is received from the secondary device 30A. For example, the primary device 20 is capable of determining that retransmission is performed if a time margin allowing retransmission to be performed before an end time of a current communication event is present, and determining that retransmission is not performed if the time margin is not present. At step S240, when determined that retransmission is performed, the primary device 20 performs the processes from step S210 again. When determined that the data is correctly received in the process at step S230 or determined that retransmission is not performed at step S240, the primary device 20 proceeds to a process at step S250.

At step S250, the primary device 20 transmits the received data to the control apparatus 1. The control apparatus 1 performs a process based on the information included in the received data. Here, when a determination that the data is not correctly received is made in the process at step S230, or the signal indicating that the data request is not correctly received is received from the secondary device 30A and a determination that retransmission is not performed is made in the process at step S240, the process at step S250 may be omitted. Alternatively, the process at step S250 may be performed based on previously received data.

At step S260, the primary device 20 detects communication quality data indicating the communication quality such as received signal strength (RSSI) and a packet error rate (PER) as characteristic data indicating the communication quality of the signal received from the secondary device 30A. The RSSI is an index indicating strength of the signal transmitted from the secondary device 30A and received by the primary device 20. PER is a proportion of a number of error packets to a number of received packets of the primary device 20 expressed in percentage. The primary device 20 may detect a signal-to-noise ratio (SNR) / signal-to-interference-plus-noise ratio (SINR) instead of the RSSI. For example, the SNR / SINR is capable of being detected by a ratio of an RSSI value when the primary device 20 receives a wireless signal from the secondary device 30A to a RSSI value when the wireless signal is not received. In addition, the primary device 20 may detect a bit error rate (BER) or a packet arrival rate (PAR) instead of the PER. For each communication channel, the primary device 20 stores and accumulates the detected RSSI or SNR / SINR and PER, BER, or PAR. Here, in addition to or instead of being detected by the primary device 20 as described above, the communication quality data can also be acquired by the secondary device 30A detecting the RSSI, the PER, and the like when receiving a signal from the primary device 20 and transmitting the RSSI, the PER, and the like to the primary device 20.

At step S270, the primary device 20 determines a decrease in the communication quality of the communication channel to be used for wireless communication with the secondary device 30A based on the communication quality data of the communication channel detected at step S260. Then, the primary device 20 removes the communication channel of which the communication quality is determined to have insufficient from the communication channels to be used for wireless communication between the primary device 20 and the secondary device 30A. The communication channel to be removed is a data communication channel. For example, an example of a condition for determining the decrease in communication quality is that, upon comparison between the RSSI and an RSSI threshold, and comparison between the PER and a PER threshold, at least either of the RSSI and the PER does not meet the threshold. Here, a parameter to be compared to a threshold may be one type. In addition, the parameter to be compared to a threshold may be an immediately preceding parameter detected at step S260, a value obtained by averaging a predetermined number of parameters detected in a plurality of previous wireless communications regarding the same communication channel, or a median value thereof.

At step S280, the primary device 20 performs a restoration determination for a communication channel removed by a removal determination at a communication event up to a current point. In this restoration determination, the removed communication channel is restored as a communication channel to be used for wireless communication if a predetermined restoration condition is met. For example, as an example of the predetermined restoration condition, the removed communication channel may be restored based on elapse of a predetermined amount of time after the removal of the communication channel. Alternatively, as another example of the predetermined restoration condition, the removed communication channel may be restored as a communication channel to be used for wireless communication based on a communication channel adjacent to the removed communication channel indicating good communication quality. In this manner, a communication channel determined to be restorable as a communication channel to be used for wireless communication is incorporated into the channel map and actually used for wireless communication between the primary device 20 and the secondary device 30A. A removal determination process at step S270 and a restoration determination process at step S280 correspond to a channel map control process of the present disclosure. Here, the communication channel determined to be restored may again be subject to removal by the removal determination if the communication quality during actual use in wireless communication remains decreased.

At step S290, the primary device 20 performs a channel map generation process based on a removal determination result at step S270 and a restoration determination result at step S280. This channel map generation process will be described in detail hereafter.

Here, the channel map may be that indicating communication channels usable for wireless communication or may be that indicating unusable communication channels. In addition, the channel map may be that indicating both the usable communication channels and the unusable communication channels. Furthermore, in a case in which a change occurs in the usable/unusable communication channels by the channel map being generated, a frequency hopping pattern may be updated. In a case in which the frequency channel hopping pattern is not updated, if the communication channel to which hopping is expected is unusable, for example, a next communication channel to which hopping is expected may be used.

In addition, the removal determination process and the restoration determination process described above may be performed every time communication is performed between the primary device 20 and the secondary device 30A. Alternatively, the removal determination process and the restoration determination process may be collectively performed in time with an update cycle of the channel map that is updated at a predetermined cycle, that is, every time communication is performed between the primary device 20 and the secondary device 30A a plurality of times. In this case, every time the communication between the primary device 20 and the secondary device 30A is performed, characteristic data indicating the communication quality of the communication channel used for the communication is detected and accumulated at step S260. Then, based on the accumulated characteristic data, for example, the removal determination at step S270 and the restoration determination at step S280 are collectively performed before start of the channel map update cycle indicated in the time chart in FIG. 7. In a similar manner, regarding the generation process for the channel map at step S290 as well, the process may be performed every time communication is performed between the primary device 20 and the secondary device 30A. Alternatively, the channel map generation process may be performed in time with the channel map update cycle, before the start of a new channel map update cycle, and transmission to the secondary device 30A may be possible during the new channel update cycle.

At step S300, the primary device 20 transmits the channel map generated by the channel map generation process at step S290 to the secondary device 30A. At this time, the primary device 20 also transmits information indicating a timing at which to start using the channel map together with the channel map. The timing at which to start using the channel map arrives every time the channel map update cycle elapses. In other words, the timing at which to start using the channel map is prescribed based on the channel map update cycle. Furthermore, as described hereafter, the channel map generated by the channel map generation process is also updated every time the channel map update cycle elapses.

At step S440, the secondary device 30A receives the new channel map and timing information transmitted from the primary device 20. Upon receiving the new channel map and timing information at step S440, at step S450, the secondary device 30A performs the checksum determination based on the error detection code included in the received packet to confirm whether the new channel map and timing information are correctly received. When determined that the new channel map and timing information are not correctly received based on the checksum determination result at step S450, for example, at step S460, the secondary device 30A does not transmit a reception confirmation signal (Ack signal) for the new channel map. Meanwhile, when determined that the new channel map and timing information are correctly received at step S450, at step S460, the secondary device 30A returns the reception confirmation signal (Ack signal) for the new channel map to the primary device 20.

At step S310, the primary device 20 receives the Ack signal from the secondary device 30A. Then, at step S320, the primary device 20 performs the checksum determination, for example, based on an error detection code included in the received Ack signal to confirm whether the Ack signal is correctly received. Here, in a case in which the primary device 20 is unable to receive the Ack signal itself, the checksum determination result is NG. At following step S330, the primary device 20 determines whether to retransmit the new channel map and timing information during the same communication event based on whether the checksum determination result at step S320 is OK or NG. More specifically, when the checksum determination result is OK, or when the checksum determination result is NG but the time margin for retransmission during the current communication event is not present, the primary device 20 determines that retransmission is not performed during the current communication event and ends the process shown in the flowchart in FIG. 5. Meanwhile, when the checksum determination result is NG and the time margin for retransmission is present, the primary device 20 returns to step S300 and retransmits the new channel map and timing information. Here, in a case in which the checksum determination result is OK, and the new channel map and timing information are successfully shared between the primary device 20 and the secondary device 30A, the primary device 20 need not transmit the new channel map and timing information in subsequent communication events until the channel map update cycle expires.

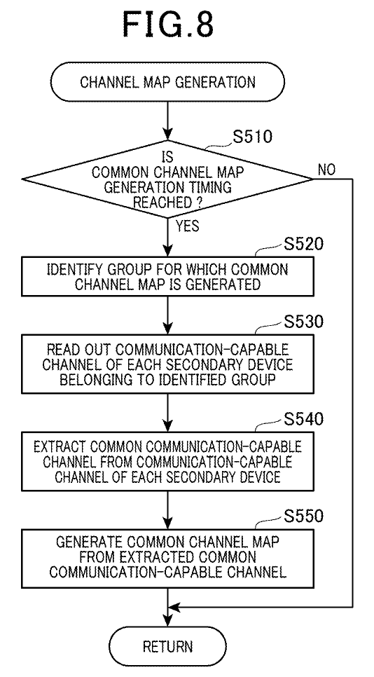

Next, the channel map generation process will be described with reference to a flowchart in FIG. 8. FIG. 8 is a flowchart showing an example of the channel map generation process performed by the primary device 20 (or control apparatus 1).

Here, when the primary device 20 performs wireless communication with the plurality of secondary devices 30A, 30B, 40A, and 50A, a common communication channel being extracted from the communication channels usable by the secondary devices 30A, 30B, 40A, and 50A and a channel map common to secondary devicess 30A, 30B, 40A, and 50A being generated can be considered. A reason for this is that, as a result of such a common channel map being generated, various processes related to the channel map, such as update, storage, and transmission of the channel map, that are necessary for wireless communication with each of the plurality of secondary devices 30A, 30B, 40A, and 50A can be facilitated. However, if the common channel map is simply generated for the plurality of secondary devices 30A, 30B, 40A, and 50A with which the primary device 20 performs wireless communication, securing a sufficient number of communication channels usable for wireless communication may be difficult, such as in a case in which the number of communication channels common among the secondary devices 30A, 30B, 40A, and 50A is small.

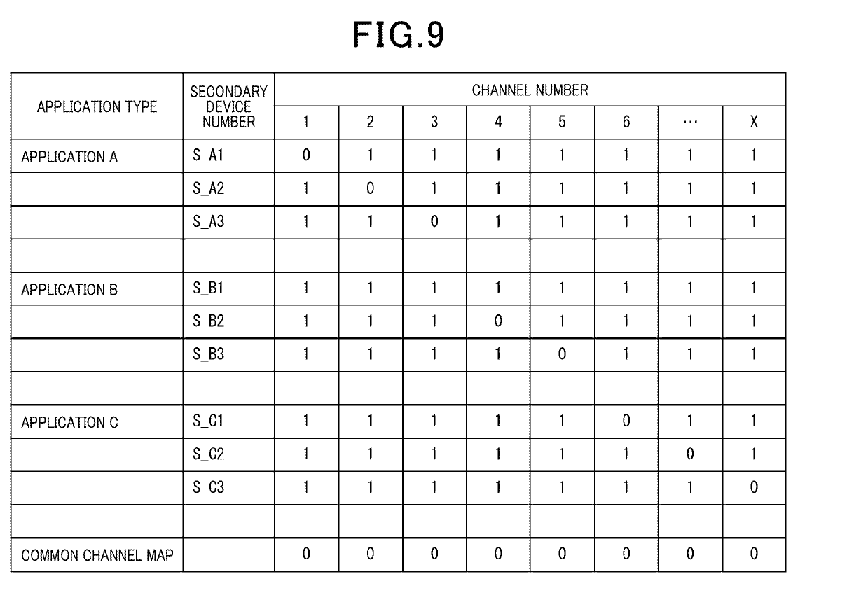

For example, a table in FIG. 9 shows an example in which a vehicle application A, a vehicle application B, and a vehicle application C are respectively associated with three secondary devices S_A1 to S_A3, S_B1 to S_B3, and S_C1 to S_C3, and the primary device 20 communicates with a total of nine secondary devices S_A1 to S_A3, S_B1 to S_B3, and S_C1 to S_C3. In the table in FIG. 9, a communication channel usable by the secondary devices S_A1 to S_A3, S_B1 to S_B3, and S_C1 to S_C3 for wireless communication is indicated by 1 and an unusable communication channel is indicated by 0. In addition, regarding the common channel map, results of an AND operation of 1 indicating the usable communication channel and 0 indicating the unusable communication channel of the secondary devices S_A1 to S_A3, S_B1 to S_B3, S_C1 to S_C3 are shown. That is, the common channel map indicates the communication channels usable by all secondary devices S_A1 to S_A3, S_B1 to S_B3, and S_C1 to S_C3. As shown in the example in FIG. 9, if the primary device 20 simply generates a common channel map for all secondary devices S_A1 to S_A3, S_B1 to S_B3, and S_C1 to S_C3, the common communication channel usable for communication may be zero.

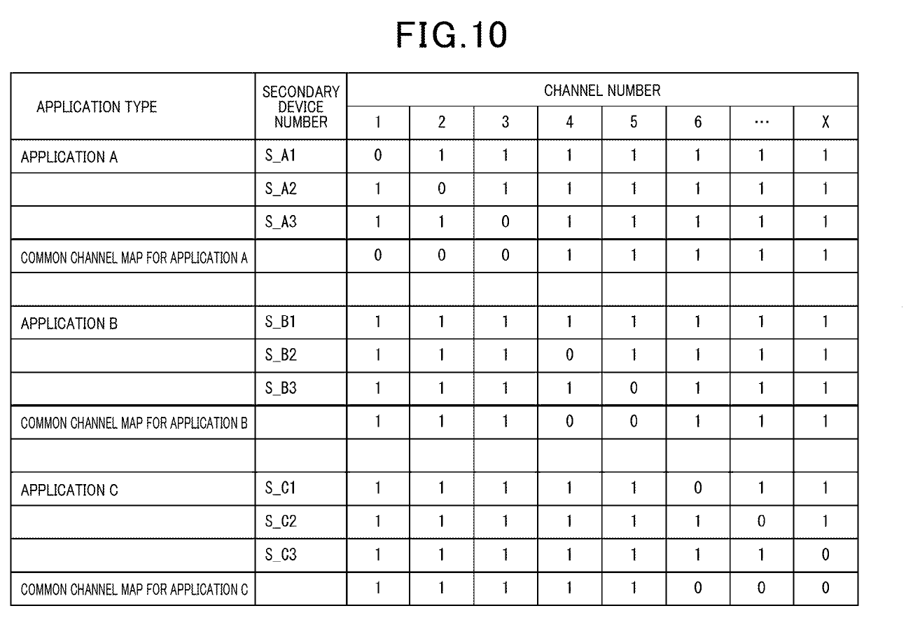

Therefore, according to the present embodiment, as described above, the plurality of secondary devices 30A, 30B, 40A, and 50A are grouped by vehicle application, and a common channel map is generated for each group. As a result, for example, as shown in a table in FIG. 10, when the vehicle application A, the vehicle application B, and the vehicle application C are respectively associated with three secondary devices S_A1 to S_A3, S_B1 to S_B3, and S_C1 to S_C3, a common channel map for the vehicle application A, a common channel map for the vehicle application B, and a common channel map for the vehicle application C are generated. Because the common channel map is generated for each group in this manner, each common channel map can secure a sufficient number of communication channels usable for communication.

Therefore, according to the present embodiment, occurrence of a situation in which the number of communication channels cannot be sufficiently secured can be suppressed, while the common channel map is used for the plurality of secondary devices 30A, 30B, 40A, and 50A.

At a first step S510 in a flowchart in FIG. 8, the primary device 20 determines whether a common channel map generation timing for the secondary device 30A performing communication is reached. For example, in the time chart in FIG. 7, the common channel map generation timing is set immediately before the start of the new channel map update cycle. As a result, the generated common channel map is transmitted from the primary device 20 to the secondary device 30A during the new channel map update cycle, and the common channel map is capable of being shared between the primary device 20 and the secondary device 30A.

Here, a length and/or a phase of the channel map update cycle may differ between at least two groups. When the length and/or the phase of the channel map update cycle differ between at least two groups, the common channel map generation timing may also differ by group.

At step S520, the primary device 20 identifies a group for which the common channel map is generated. For example, the primary device 20 is capable of identifying the group for which the common channel map is generated by identifying the group to which the secondary device 30A belongs based on the identification information and/or the group information received from the secondary device 30A performing wireless communication. At step S530, the primary device 20 selects the secondary devices 30A, 30B, 40A, and 50A belonging to the identified group by referencing the list or the like, and reads out the channels usable for communication by the selected secondary devices 30A, 30B, 40A, and 50A. At step S540, the primary device 20 extracts a common communication-capable channel that is a common communication-capable channel from the communication-capable channels of the secondary devices 30A, 30B, 40A, and 50A that have been read. Then, at step S550, the primary device 20 generates a common channel map from the extracted common communication-capable channels.

In this manner, a new common channel map is generated for each group every time the channel map update cycle elapses. At step S300 in the flowchart in FIG. 5, described above, as indicated in the time chart in FIG. 7, the generated common channel map is transmitted to the secondary device 30A at least until the sharing of the common channel map is successful in the channel map update cycle that is a period over which a current common channel map is applied. Then, the primary device 20 and the secondary device 30A switch the common channel map used in the next update cycle to the common channel map that is successfully shared, together with the start of the new channel map update cycle. As a result, as shown in the time chart in FIG. 7, in the next update cycle, wireless communication between the primary device 20 and the secondary device 30A is performed using the new common channel map that is successfully shared. As a result of the common channel map being periodically updated in this manner, the primary device 20 and the secondary device 30A are capable of performing high-quality communication using the common channel map adapted to changes in the communication quality of each communication channel.

### Second embodiment

Next, the wireless communication system 10 according to a second embodiment of the present disclosure will be described with reference to the drawings. The wireless communication system 10 according to the present embodiment is configured in a manner similar to the wireless communication system 10 according to the first embodiment. Therefore, descriptions related to the configuration are omitted.

In the wireless communication system 10 according to the first embodiment described above, the plurality of secondary devices 30A, 30B, 40A, and 50A are grouped by vehicle application, and a common channel map is generated for each group. However, required communication quality may vary depending on the vehicle application. For example, in the tire air-pressure monitoring system, because changes over time in the air pressure of a tire to be monitored are slight, even if communication errors occur several times over a short amount of time during wireless communication by the wireless communication system 1, significant issues do not arise. In addition, for example, in a case in which an entertainment system that connects a mobile device brought in by an occupant of the vehicle and an in-vehicle system, and plays music, video, and the like stored in the mobile device is constructed as the vehicle application, communication quality of wireless communication need not be high quality because control of the vehicle is not directly affected.

In contrast, for example, changes in a state (such as a voltage or a temperature) over time of a battery targeted by the battery management system is greater than the changes over time in the tire air-pressure and the like. Therefore, in the case in which the wireless communication system 10 is applied to the battery management system, communication errors are preferably avoided as much as possible.

Therefore, according to the present embodiment, the wireless communication system 10 is configured to differentiate determination criteria for excluding from a target for updating the channel map and determining the communication channel to be used for wireless communication to ensure communication quality based on the groups corresponding to the vehicle applications. For example, as a result of the secondary device belonging to one group being excluded from an update target of the channel map, processing load for performing channel map control in the primary device 20 or the control apparatus 1 can be reduced. In addition, for example, as a result of a criterion for removing a communication channel being relaxed for a vehicle application that does not requiring stringent communication quality, wireless communication can be performed using more communication channels.

The wireless communication system 10 according to the present embodiment will be described hereafter, mainly focusing on differences from the wireless communication system 10 according to the first embodiment described above. The wireless communication system 10 according to the present embodiment and the wireless communication system 10 according to the first embodiment mainly differ regarding processes in the communication sequence.

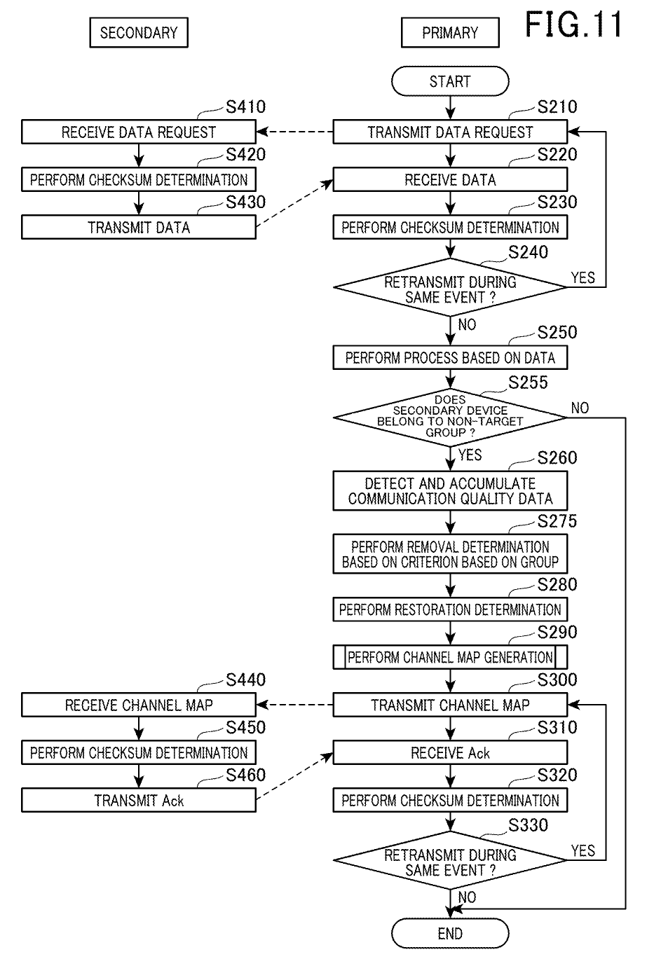

FIG. 11 is a flowchart showing an example of a communication sequence of the wireless communication system 10 according to the present embodiment. The flowchart in FIG. 11 is the flowchart in FIG. 5 to which a process at step S255 is added. In addition, in the flowchart in FIG. 11, a process at step S275 is performed instead of step S270 in the flowchart in FIG. 5.

At step S255, the primary device 20 determines whether the secondary devices 30A, 30B, 40A, and 50A performing communication are secondary devices belonging to a non-target group that is excluded from the update target of the channel map. When the secondary device belongs to the non-target group, the primary device 20 does not perform the processes at step S260 and subsequent steps, and ends the communication sequence shown in the flowchart in FIG. 11. Therefore, regarding the secondary device that belongs to the non-target group, the determination of the communication channel to be used for wireless communication through the removal of the communication channel and the restoration of the communication channel at steps S275 and S280, and the generation of the common channel map are not performed. The secondary device belonging to the non-target group is capable of communicating with the primary device 20 by continuously using the initial common channel map exchanged as a part of the connection information in the startup sequence.

Here, whether each secondary device belonging to a predetermined group is excluded from the update target of the channel map may be determined based on the communication quality of each secondary device belonging to the predetermined group. For example, in a case in which the communication quality data of each secondary device belonging to the predetermined group all exceed a predetermined criterion, a determination that the quality of wireless communication between the primary device and each secondary device belonging to the predetermined group is favorably maintained can made. In such cases, each secondary device belonging to the predetermined group may be excluded from the target for updating the channel map. However, in this case, because the communication quality data of each secondary device is required to be acquired, at least the process at step S260 and the processes for determining the communication quality at steps S275, S280, and the like in the flowchart in FIG. 11 are required to be performed. Then, if any of the communication quality data of the secondary devices belonging to the predetermined group degrades or the like, restoration to the update target of the channel map may be performed. Alternatively, at least one predetermined secondary device belonging to the predetermined group may be excluded from the update target of the channel map. In this case, the common channel map for the predetermined group is generated from the communication usable channels of the remaining secondary devices excluding the predetermined at least one secondary device. In other words, the communication usable channels of the predetermined at least one secondary device are excluded from a calculation target for generating the common channel map. In this case, when the common channel map for the predetermined group is generated and updated, because the predetermined at least one secondary device also belongs to the predetermined group, wireless communication with the primary device 20 may be performed using the updated common channel map.

At step S275, the primary device 20 determines the decrease in the communication quality of the communication channel to be used for wireless communication with the secondary device 30A based on the communication quality data of the communication channel detected at step S260, in a manner similar to that at step S270 in the flowchart in FIG. 5. Then, the primary device 20 removes the communication channel of which the communication quality is determined to have insufficient from the communication channels used for wireless communication between the primary device 20 and the secondary device 30A. However, at step S275, the primary device 20 determines the decrease in communication quality by the determination criterion based on the group to which the secondary device 30A that has communicated belongs. When high communication quality is required, the determination criterion is set to be more stringent. For example, when the communication quality is determined based on the RSSI, a threshold serving as the determination criterion is set relatively high. When the communication quality is determined based on the PER, a threshold serving as the determination criterion is set relatively low. Conversely, when such a high communication quality is not required, the determination criterion is relaxed. For example, when the communication quality is determined based on the RSSI, the threshold serving as the determination criterion is set relatively low. When the communication quality is determined based on the PER, the threshold serving as the determination criterion is set relatively high. As a result, whether removal of the communication channel is required can be determined based on a degree of communication quality that is required.

Here, the flowchart in FIG. 11 only indicates the determination criterion for removal determination of the communication channel being prescribed based on the group to which a subject secondary device belongs. However, the determination criterion may also be prescribed based on the group to which the subject secondary device belongs for the restoration determination of the communication channel at step S280 as well. For example, when high communication quality is required, wait time until the removed communication channel is restored may be set to be longer as the restoration determination criterion. Alternatively, when whether to restore the removed communication channel is determined based on the communication quality of an adjacent channel, restoration may be permitted when the communication quality of the adjacent channel meets a higher determination criterion.

### Third embodiment

Next, the wireless communication system 10 according to a third embodiment of the present disclosure will be described with reference to the drawings. The wireless communication system 10 according to the present embodiment is configured in a manner similar to the wireless communication system 10 according to the first embodiment. Therefore, descriptions related to the configuration are omitted.

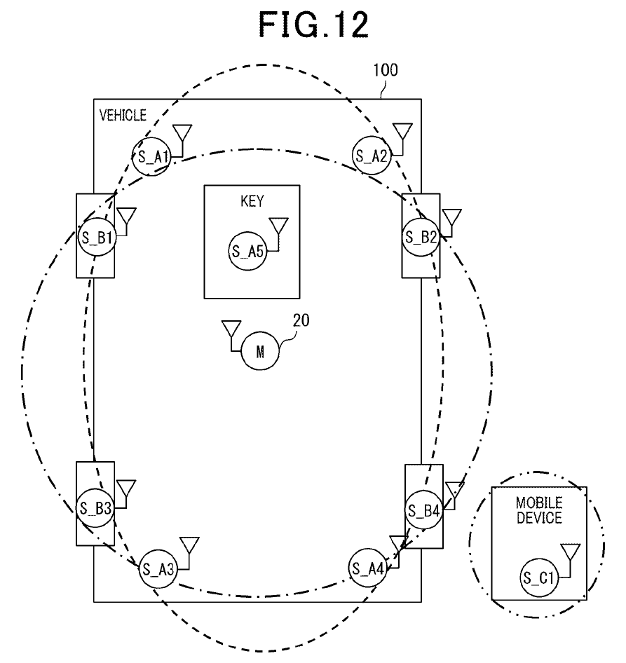

In the wireless communication system 10 according to the first embodiment described above, the plurality of secondary devices 30A, 30B, 40A, and 50A are grouped by vehicle application. FIG. 12 shows an arrangement example in the vehicle 100 of a plurality of secondary devices S_A1 to S_A5, S_B1 to S_B4, and S_C1 grouped by vehicle application. In FIG. 12, the secondary devices S_A1 to S_A5 are associated with the smart key system. The secondary devices S_B1 to S_B4 are associated with the tire air-pressure monitoring system. In addition, in the example shown in FIG. 12, the secondary device S_C1 of a mobile device held by an occupant is grouped into a single group.

When the groups are formed by vehicle application, as shown in FIG. 12, the arrangement of the corresponding secondary devices S_A1 to S_A5, S_B1 to S_B4, and S_C1 may be extensive. In this case, communication environments (such as effects of vibration and noise) of individual secondary devices S_A1 to S_A5 and S_B1 to S_B4 belonging to the same group differing can be considered. Therefore, when groups are formed by vehicle application, for example, if a secondary device of which the communication environment is degraded is included, the number of communication-capable channels included in the common channel map may decrease as a result.

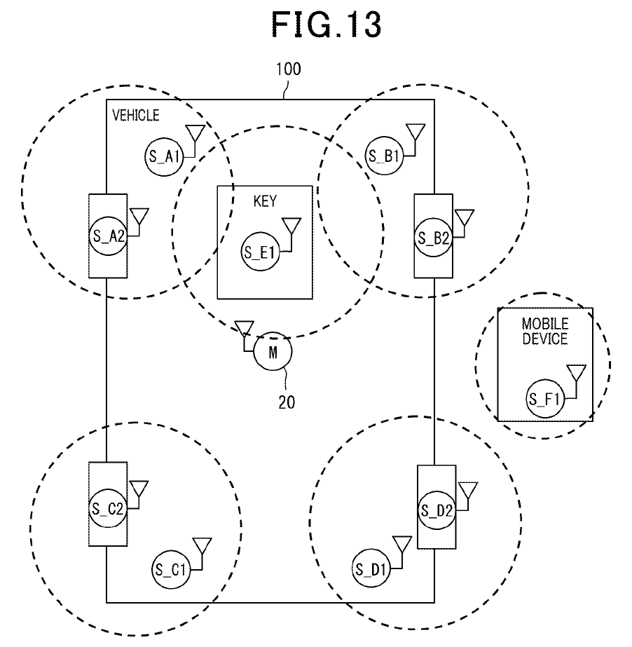

In contrast, according to the present embodiment, as shown in FIG. 13, a plurality of secondary devices S_A1 and S_A2, S_B1 and S_B2, S_C1 and S_C2, S_D1 and S_D2, S_E1, and S_F1 that perform wireless communication with the primary device 20 are grouped for each of a plurality of areas prescribed to include, in any area, arrangement positions of the plurality of secondary devices S_A1 and S_A2, S_B1 and S_B2, S_C1 and S_C2, S_D1 and S_D2, S_E1, and S_F1, with reference to a setup position of the primary device 20. In the example shown in FIG. 13, six areas are prescribed such that the secondary devices S_A1 and S_A2, the secondary devices S_B1 and S_B2, the secondary devices S_C1 and S_C2, the secondary devices S_D1 and S_D2, the secondary device S_E1, and the secondary device S_F1 respectively form groups.

If a plurality of areas is set with reference to the position of the primary device 20, and the secondary devices S_A1 and S_A2, S_B1 and S_B2, S_C1 and S_C2, S_D1 and S_D2, S_E1, and S_F1 included in the areas be grouped in such a manner, the secondary devices S_A1 and S_A2, S_B1 and S_B2, S_C1 and S_C2, S_D1 and S_D2, S_E1, and S_F1 having a similar communication environment can be grouped together.

According to the present embodiment as well, the secondary device belonging to at least one group among the plurality of groups that are grouped may be excluded from the target for updating the channel map to ensure communication quality. For example, in a case in which the communication quality data of the secondary devices belonging to at least one group among the plurality of groups that are grouped all exceed a predetermined criterion, a determination that the quality of wireless communication between the primary device 20 and the secondary devices belonging to the corresponding group is favorably maintained can be made. In such a case, the secondary devices belonging to the subject group may be excluded from the target for updating the channel map. However, in this case, because the communication quality data of each secondary device is required to be acquired, at least the process at step S260 and the processes for determining the communication quality at steps S275, S280, and the like are required to be performed.

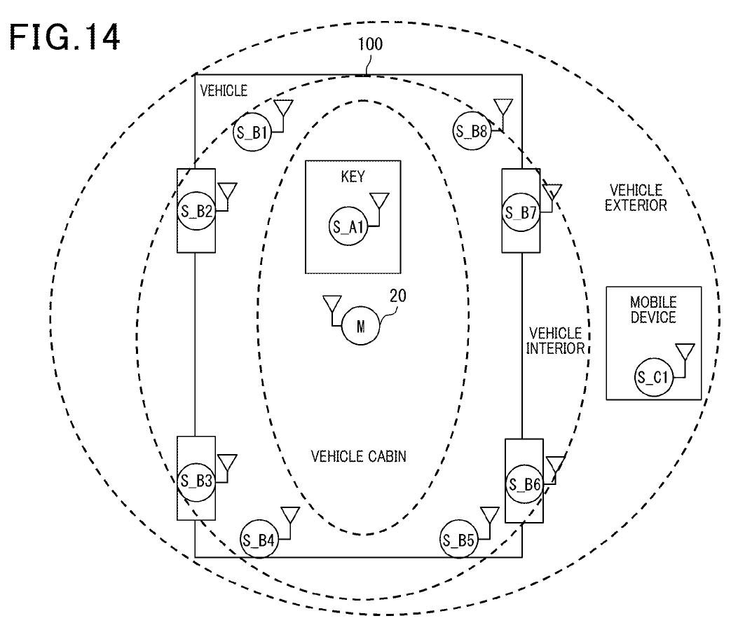

In addition, FIG. 13 shows an example in which a plurality of relatively small areas are prescribed around the primary device 20 with reference to the setup position of the primary device 20. However, a method of prescribing the areas is not limited to the example shown in FIG. 13. For example, as shown in FIG. 14, a vehicle cabin area, a vehicle interior area, and a vehicle exterior area may be prescribed with reference to the setup position of the primary device 20, and the secondary devices S_A1, S_B1 to S_B8, and S_C1 included in the respective areas may be grouped.

### Fourth embodiment

Next, the wireless communication system 10 according to a fourth embodiment of the present disclosure will be described with reference to the drawings. The wireless communication system 10 according to the present embodiment is configured in a manner similar to the wireless communication system 10 according to the first embodiment. Therefore, descriptions related to the configuration are omitted.

In the wireless communication system 10 according to the third embodiment described above, a plurality of areas are prescribed with reference to the setup position of the primary device 20, and the secondary devices belonging to the respective areas are grouped. In contrast, in the wireless communication system 10 according to the present embodiment, a plurality of antennas are provided in the primary device 20. A plurality of areas are prescribed with reference to setup positions of the plurality of antennas, and the secondary devices belonging to the respective areas are grouped.

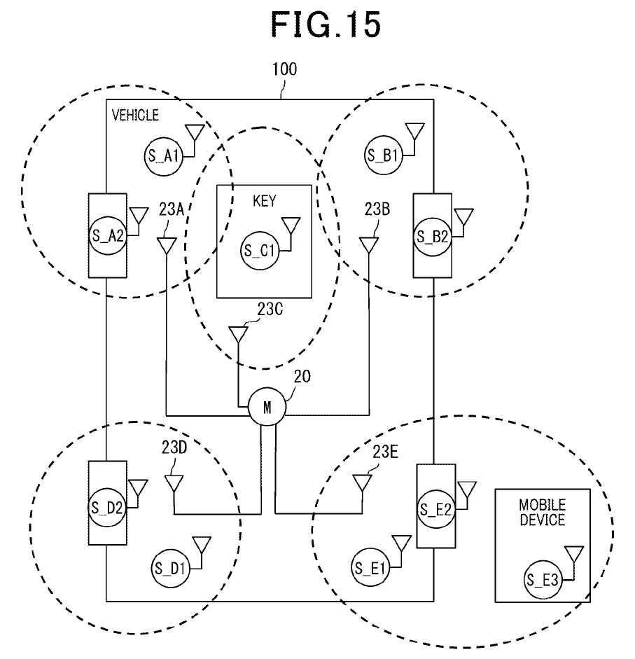

For example, as shown in FIG. 15, the primary device 20 has a plurality of antennas 23A to 23E for performing wireless communication with a plurality of secondary devices S_A1 and S_A2, S_B1 and S_B2, S_C1, S_D1 and S_D2, and S_E1 to S_E3. The plurality of antennas 23A to 23E are respectively set in differing positions of the vehicle 100. Then, the plurality of secondary devices S_A1 and S_A2, S_B1 and S_B2, S_C1, S_D1 and S_D2, and S_E1 to S_E3 that perform wireless communication with the primary device 20 are grouped for each of a plurality of areas prescribed to include, in any area, arrangement positions of the plurality of secondary devices S_A1 and S_A2, S_B1 and S_B2, S_C1, S_D1 and S_D2, and S_E1 to S_E3 with reference to the setup positions of the plurality of antennas 23A to 23E.

Therefore, in the wireless communication system 10 according to the present embodiment, the secondary devices S_A1 and S_A2, S_B1 and S_B2, S_C1, S_D1 and S_D2, and S_E1 to S_E3 having a similar communication environment can be grouped together in a manner similar to that according to the third embodiment.

### Fifth embodiment

Next, the wireless communication system 10 according to a fifth embodiment of the present disclosure will be described with reference to the drawings. The wireless communication system 10 according to the present embodiment is configured in a manner similar to the wireless communication system 10 according to the first embodiment. Therefore, descriptions related to the configuration are omitted.

According to the first embodiment described above, the associated secondary devices are grouped by vehicle application. In addition, according to the third embodiment and the fourth embodiment, a plurality of areas are prescribed with reference to the setup position of the primary device 20 or the plurality of antennas 23A to 23E, and the secondary devices belonging to each area are grouped. However, a method for grouping is not limited to the methods described above. For example, grouping may be performed such that a fixed secondary device set up in a fixed position and a movable secondary devices that is movable are in differing groups.

According to the fifth embodiment, several examples in which the fixed secondary device and the movable secondary device are grouped in differing groups will be described below.

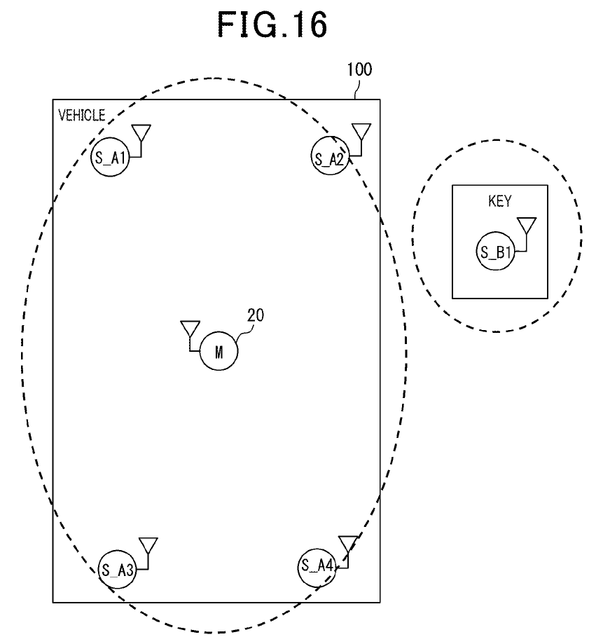

In FIG. 16, the wireless communication system 10 related to the smart key system is shown as an example according to the present embodiment. In the example shown in FIG. 16, the primary device 20 and four secondary devices S_A1 to S_A4 are set in predetermined fixed positions of the vehicle 100. That is, the four secondary devices S_A1 to S_A4 are fixed secondary devices. In addition, one secondary device S_B1 is mounted in an electronic key held by an occupant of the vehicle 100. That is, the one secondary device S_B1 is a movable secondary device. Here, if a plurality of electronic keys are present within a range over which communication with the primary device 20 is possible, the plurality of secondary devices mounted in the plurality of electronic keys may be grouped into a single group. Alternatively, the plurality of secondary devices mounted in the plurality of electronic keys may be grouped as separate groups.

The communication environment of the fixed secondary device is considered to have few changes over time compared to the communication environment of the movable secondary device. Therefore, as described above, as a result of the fixed secondary device and the movable secondary device being grouped into differing groups, a channel map suitable for each group can be generated and updated.

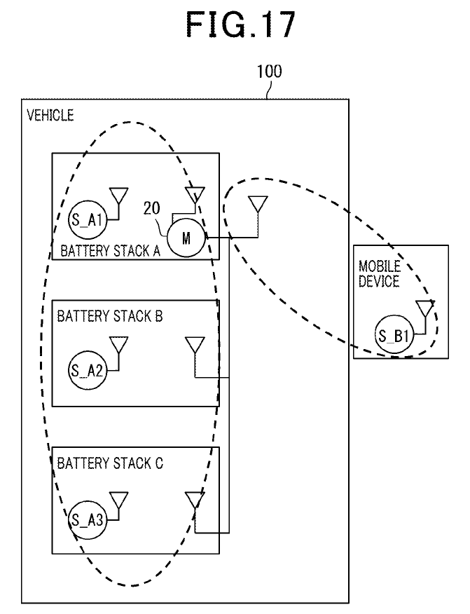

FIG. 17 shows a wireless communication system 10 of related to the battery management system as another example according to the present embodiment. In the example shown in FIG. 17, three battery stacks A to C configuring a battery pack are mounted in the vehicle 100. Each of the three battery stacks A to C is housed in a separate housing. Secondary devices S_A1 to S_A3 are respectively set in the housings of the three battery stacks A to C. That is, the secondary devices S_A1 to S_A3 are fixed secondary devices. The primary device 20 is set in the housing of the battery stack A. The primary device 20 has a plurality of antennas. The plurality of antennas are set inside the housing of the battery stack A, outside the housing of the battery stack A, inside the housing of the battery stack B, and inside the housing of the battery stack C. As a result, the primary device 20 is capable of performing wireless communication with the secondary devices S_A1 to S_A3 disposed inside the housings under substantially equivalent conditions.

The battery management system uses a wireless unit of a mobile device (such as a smartphone) held by an occupant of the vehicle 100 as a secondary device S_B1. The mobile device provides a function for receiving information related to the state of the battery (such as the amount of charge and the temperature) through, for example, wireless communication between the primary device 20 and the secondary device S_B1, and displaying the information. The secondary device S_B1 of the mobile device corresponds to the movable secondary device.

As shown in FIG. 17, the secondary devices S_A1 to S_A3 that are the fixed secondary devices and the secondary device S_B1 that is the movable secondary device are grouped into differing groups. As a result, a channel map suitable for each group can be generated and updated in a manner similar to the example shown in FIG. 16.

Here, in the examples shown in FIG. 16 and FIG. 17, the secondary device S_B1 that is the movable secondary device may be excluded from the target for periodic updating of the channel map. Furthermore, when the movable secondary device S_B1 communicates wirelessly with the primary device 20, the movable secondary device S_B1 may function as the primary device and the primary device 20 may function as the secondary device.

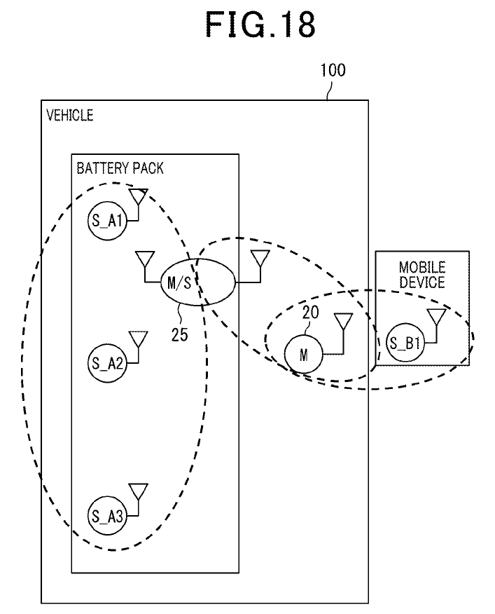

In addition, the configuration of the wireless communication system 10 related to the battery management system shown in FIG. 17 is capable of being modified in various ways. For example, as shown in FIG. 18, the battery stacks A to C configuring the battery pack may be housed in a common housing rather than being housed in individual housings. In addition, a wireless apparatus 25 that provides a function as the primary device disposed inside the housing may be configured to also function as the secondary device. In this case, the wireless apparatus 25 is configured to act as the primary device when communicating wirelessly with the secondary devices S_A1 to S_A3 disposed inside the housing of the battery pack, and to act as the secondary device when communicating wirelessly with the primary device 20 separately provided inside the vehicle 100. That is, in this case, the wireless apparatus 25 serves as a relay apparatus in communication with each secondary device S_A1 to S_A3 connected to the monitoring apparatuses of the battery stacks housed inside the housing and the primary device 20.

As a result of a configuration such as that shown in FIG. 18, the primary device 20 need not communicate individually with each secondary device S_A1 to S_A3 connected to the monitoring apparatuses of the battery packs, and is capable of acquiring information relating to the battery stack included in each battery pack and controlling the state of the battery stack by merely communicating with the wireless apparatus 25 acting as the relay apparatus. Furthermore, in a case in which battery performance of the battery pack decreases as a result of degradation over time, replacement of the battery pack can be easily performed.

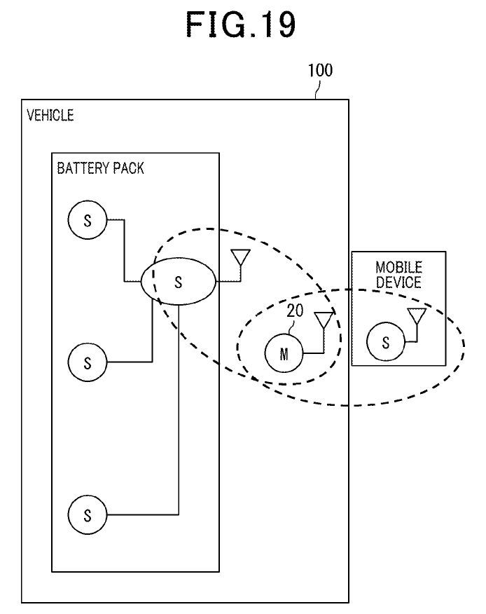

Here, the communication between the wireless apparatus 25 and each secondary device S_A1 to S_A3 inside the battery pack may be wired communication as shown in FIG. 19, rather than wireless communication. In this case, the wireless apparatus 25 need only provide a function as the secondary device that communicates wirelessly with the primary device 20.

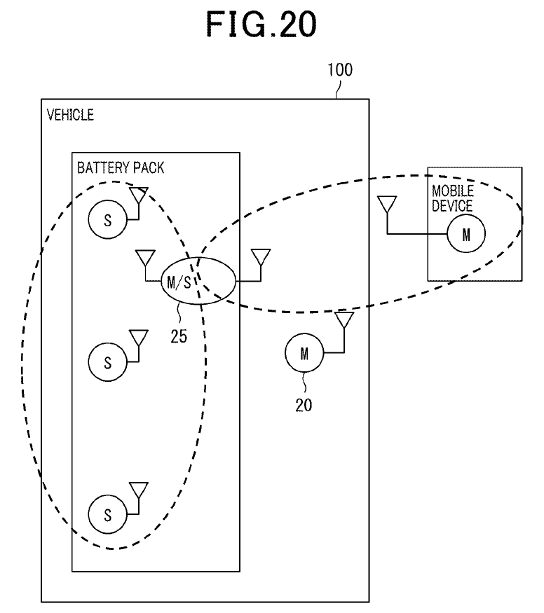

Alternatively, as shown in FIG. 20, the configuration may be such that the wireless apparatus of the mobile device functions as the primary device, and the wireless apparatus 25 disposed inside the housing of the battery pack functions as the secondary device. In addition, as described above, the wireless apparatus of the mobile device may communicate wirelessly with the primary device 20 such that the wireless apparatus of the mobile device that is the movable secondary device functions as the primary device, and the primary device 20 functions as the secondary device.

### Sixth embodiment

Next, the wireless communication system 10 according to a sixth embodiment of the present disclosure will be described with reference to the drawings. The wireless communication system 10 according to the present embodiment is configured in a manner similar to the wireless communication system 10 according to the first embodiment. Therefore, descriptions related to the configuration are omitted.

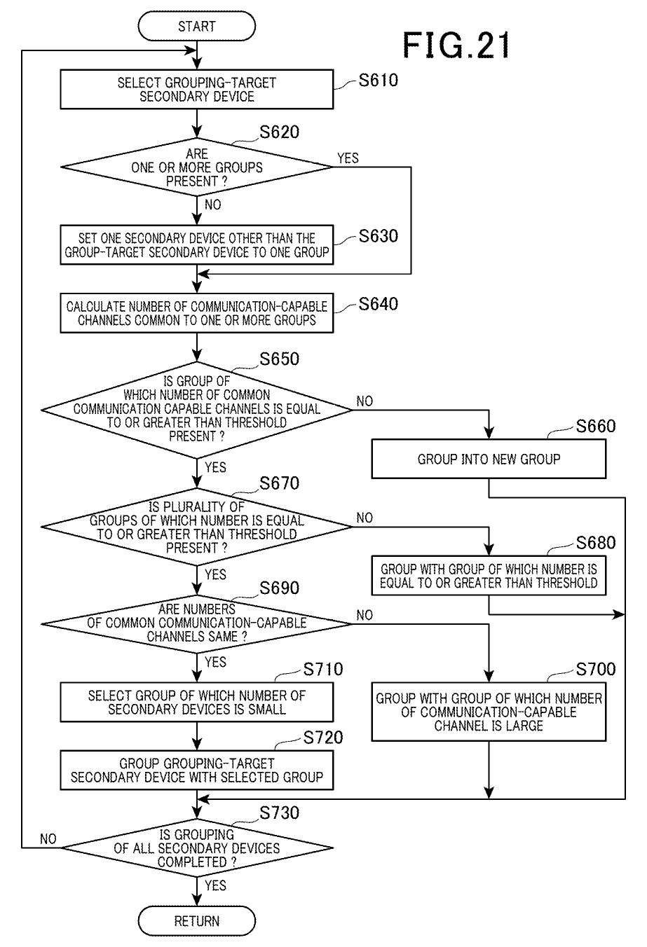

According to the present embodiment, a method of grouping the plurality of secondary devices 30A, 30B, 40A, and 50A into a plurality of groups using a method differing from those according to the embodiments described above will be described. The grouping method according to the present embodiment dynamically groups the plurality of secondary devices 30A, 30B, 40A, and 50A such that the number of common communication channels is equal to or greater than a predetermined threshold based on the communication channels used for wireless communication determined for each of the plurality of secondary devices 30A, 30B, 40A, and 50A, rather than grouping the secondary devices 30A, 30B, 40A, and 50A into a plurality of groups in advance based on the application, area, whether the secondary device is fixed or movable, and the like. Therefore, according to the present embodiment, it can be said that secondary devices having similar communication environments are grouped together based on the number of common communication channels. Here, the secondary devices belonging to each group may change with the elapse of time or may be unchanged. FIG. 21 is a flowchart showing the grouping method according to the present embodiment.

At a first step S610, the primary device 20 selects a single arbitrary secondary device (such as the secondary device 30A) serving as a target for grouping. At step S620, the primary device 20 determines whether one or more groups are already formed. In this determination process, when a group is not yet formed, the primary device 20 proceeds to step S630. Meanwhile, when one or more groups are formed, the primary device 20 proceeds to step S640.

At step S630, the primary device 20 selects an arbitrary secondary device (such as the secondary device 30B) other than the single selected secondary device (such as the secondary device 30A) that is the grouping target, and sets a single group including the selected secondary device (such as the secondary device 30B).

At step S640, the primary device 20 determines a common communication-capable channel when the secondary device (such as the secondary device 30A) that is the grouping target is grouped with an existing group, based on the communication-capable channel of the selected secondary device (such as the secondary device 30A) that is the grouping target and the common communication-capable channel of the existing group, and calculates the number of common communication-capable channels. The common communication-capable channel of a group refers to the communication-capable channel common to the communication-capable channels of all secondary devices belonging to the group. In addition, when a plurality of existing groups are present, at step S640, the primary device 20 determines the common communication-capable channel when the secondary device (such as the secondary device 30A) that is the grouping target is grouped with an existing group and calculates the number of common communication-capable channels regarding all groups. Furthermore, when a single group is set at step S630, at step S640, the primary device 20 sets the communication-capable channel of the secondary device (such as the secondary device 30B) included in the set group as the common communication-capable channel of the group.

At step S650, the primary device 20 determines whether a group of which the number of common communication-capable channels calculated at step S640 is equal to or greater than the threshold is present. When a group of which the number of common communication-capable channels is equal to or greater than the threshold is not present, the primary device 20 proceeds to step S660. Meanwhile, when a group of which the number of common communication-capable channels is equal to or greater than the threshold is present, the primary device 20 proceeds to step S670.

At step S660, because the number of common communication-capable channels decreases to be equal to or less than the threshold when the secondary device (such as the secondary device 30A) that is the grouping target is grouped with the existing group, the primary device 20 sets a new group and groups the secondary device (such as the secondary device 30A) that is the grouping target into the new group. Meanwhile, at step S670, the primary device 20 determines whether there is a plurality of groups of which the number of common communication-capable channels is equal to or greater than the threshold. When there is not a plurality of groups of which the number of common communication-capable channels is equal to or greater than the threshold, that is, when a number of groups of which the number of common communication-capable channels is equal to or greater than the threshold is one, the primary device 20 proceeds to step S680. Meanwhile, when there is a plurality of groups of which the number of common communication-capable channels is equal to or greater than the threshold, the primary device 20 proceeds to step S690.

At step S680, the primary device 20 groups the secondary device (such as the secondary device 30A) that is the grouping target with the group of which the number of common communication-capable channels is equal to or greater than the threshold. Meanwhile, at step S690, the primary device 20 determines whether the numbers of common communication-capable channels are the same regarding the plurality of groups of which the number of common communication-capable channels is equal to or greater than the threshold. When the numbers of common communication-capable channels differ, the primary device 20 proceeds to step S700. Meanwhile, when the numbers of common communication-capable channels are the same, the primary device 20 proceeds to step S710.

At step S700, the primary device 20 selects the group having a greater number of common communication-capable channels and groups the secondary device (such as the secondary device 30A) that is the grouping target with the selected group. Meanwhile, at step S710, the primary device 20 selects the group having a smallest number of secondary devices included, regarding the plurality of groups of which the numbers of common communication-capable channels are the same. When the numbers of secondary devices included are also the same, either group may be selected. At step S720, the primary device 20 groups the secondary device (such as the secondary device 30A) that is the grouping target with the selected group.

At step S730, the primary device 20 determines whether grouping of all secondary devices is completed. When grouping of all secondary devices is not completed, the primary device 20 repeats the processes from step S610. When grouping of all secondary devices is completed, the primary device 20 ends the grouping process shown in FIG. 21.

According to the sixth embodiment as well, the secondary device belonging to at least one group that is grouped may be excluded from the update target of the channel map. For example, when the number of common communication-capable channels is equal to or greater than an exclusion threshold, because the number of channels usable for communication is many, the communication quality of the secondary devices belonging to this group can be considered to be at a high level. That is, the level of communication quality of each secondary device can be determined from the number of channels usable for communication. In such cases, the secondary device belonging to the subject group may be excluded from the update target of the channel map.

Preferred embodiments of the present disclosure are described above. However, the present disclosure is not limited in any way to the above-described embodiments. Various modifications are possible without departing from the spirit of the present disclosure.

For example, features described according to each of the embodiments described above can be implemented in combination with features described according to other embodiments, except for cases in which the combination is technically not possible.

Finally, this specification discloses a plurality of technical concepts and a plurality of combinations thereof listed below. The plurality of combinations of technical concepts applies not only to the wireless communication system 10 but also a wireless communication method and a wireless communication program.

### Aspect 1

A wireless communication system in which at least a single primary device (20) and a plurality of secondary devices (30) perform wireless communication via a single communication channel successively selected from a plurality of communication channels, the wireless communication system including: a grouping unit (S50) that groups a plurality of the secondary devices communicating wirelessly with the single primary device into two or more groups; a communication channel determination unit (S270, S280) that, when the primary device communicates wirelessly with each of the plurality of secondary devices, determines communication quality of each communication channel for secondary devices belonging to at least one group that is grouped by the grouping unit, and determines the communication channel to be used for wireless communication based on a determination result for the communication quality of each communication channel; and a generation unit (S290) that generates a common channel map by extracting a common communication channel that is a communication channel common to secondary devices belonging to the at least one group that is grouped by the grouping unit, based on the communication channel to be used for wireless communication determined by the communication channel determination unit for secondary devices belonging to the at least one group, in which the primary device and the secondary devices grouped into the at least one group perform wireless communication via the communication channel selected from the common communication channel indicated in the common channel map generated by the generation unit.

### Aspect 2

The wireless communication system according to aspect 1, in which: the generation unit periodically updates the common channel map by repeating generation of the common channel map over time; and the secondary device belonging to at least one other group other than the at least one group grouped by the grouping unit is excluded from a target for periodically updating the common channel map.

### ASPECT3

The wireless communication system according to aspect 1, in which: the secondary devices respectively belonging to two or more groups grouped by the grouping unit are set as targets for determining the communication channel to be used for wireless communication by the communication channel determination unit; and the communication channel determination unit determines the communication channel to be used for wireless communication using a determination criterion differing by group for the secondary devices respectively belonging to two or more groups

### ASPECT4

The wireless communication system according to any one of aspects 1 to 3, in which: each of the plurality of secondary devices is associated with any application to perform wireless communication with the primary device for execution of any application among a plurality of applications; and the grouping unit groups the secondary device associated with each application for each application of the plurality of applications.

### ASPECT 5

The wireless communication system according to aspect 1 or 2, in which the grouping unit groups the plurality of secondary device for each of a plurality of areas prescribed to include arrangement positions of the plurality of secondary devices performing wireless communication with the primary device in any area, with reference to a setup position of the primary device.

[Aspect 6]

The wireless communication system according to aspect 5, in which: the primary device is mounted in a vehicle; and the plurality of areas is divided into a vehicle cabin area, a vehicle interior area, and a vehicle exterior area.

### ASPECT 7

The wireless communication system according to aspect 1 or 2, in which: the primary device has a plurality of antennas for wireless communication with the plurality of secondary devices; the plurality of antennas are respectively set in differing positions; and the grouping unit groups the plurality of secondary device for each of a plurality of areas prescribed to include arrangement positions of the plurality of secondary devices performing wireless communication with the primary device in any area, with reference to setup positions of the plurality of antennas.

### ASPECT 8

The wireless communication system according to any one of aspects 1 to 7, in which: the plurality of secondary devices includes a fixed secondary device that is the secondary device set in a fixed position and a movable secondary device that is movable; and the grouping unit groups the plurality of secondary devices such that the fixed secondary device and the movable secondary device are in differing groups.

### ASPECT 9

The wireless communication system according to aspect 8, in which: the movable secondary device grouped in a differing group from the fixed secondary device is excluded from a target for periodically updating the common channel map.

### ASPECT 10

The wireless communication system according to aspect 8 or 9, in which: the movable secondary device is an electronic apparatus carried by a user; and when the movable secondary device and the primary device perform wireless communication, the movable secondary device functions as the primary device and the primary device functions as the secondary device.

### ASPECT 11

The wireless communication system according to any one of aspects 1 to 10, in which: the plurality of secondary devices have identification information for identifying each secondary device and transmit the identification information during wireless communication with the primary device; the primary device holds a list associating the identification information and information on belonging groups; the grouping unit groups the plurality of secondary devices based on the list, based on the identification information transmitted wirelessly from each of the plurality of secondary devices to the primary device.

### ASPECT 12

The wireless communication system according to any one of aspects 1 to 10, in which: the plurality of secondary devices have identification information for identifying each secondary device and group information indicating belonging groups, and transmits the identification information and the group information during wireless communication with the primary device; and the grouping unit groups the plurality of secondary devices based on the identification information and the group information transmitted wirelessly from each of the plurality of secondary devices to the primary device.

### ASPECT 13

The wireless communication system according to aspect 1 or 2, in which: the grouping unit groups the plurality of secondary devices such that a number of common communication channels is equal to or greater than a predetermined threshold, based on the communication channel used to be used for wireless communication determined for each secondary device by the communication channel determination unit.

### ASPECT 14

The wireless communication system according to aspect 13, in which: the grouping unit determines the common communication channel when the secondary device serving as a grouping target is grouped with at least one existing group based on the communication channel to be used for wireless communication with the secondary device serving as a grouping target and the common communication channel of the at least one existing group, and when a number of determined common communication channels is equal to or greater than the predetermined threshold, the secondary device serving as the grouping target is grouped with the existing group, and when the number is less than the predetermined threshold, the secondary device serving as the grouping target is grouped into a new group.

### ASPECT 15

The wireless communication system according to aspect 13 or 14, in which: the grouping apparatus determines the common communication channel when the secondary device serving as a grouping target is grouped with at least one existing group based on the communication channel to be used for wireless communication with the secondary device serving as the grouping target and the common communication channel of the at least one existing group, and when a plurality of existing groups of which a number of determined common communication channels is equal to greater than the predetermined threshold are present, the secondary device serving as the grouping target is grouped into the existing group of which the number of determined common communication channels is largest.

### ASPECT 16

The wireless communication system according to any one of aspects 13 to 15, in which: the grouping unit determines the common communication channel when the secondary device serving as a grouping target is grouped with at least one existing group based on the communication channel to be used for wireless communication with the secondary device serving as a grouping target and the common communication channel of the at least one existing group, and when a plurality of existing groups of which a number of determined common communication channels is equal to greater than the predetermined threshold are present and the numbers of determined common communication channels are same for the plurality of existing groups, the secondary device serving as the grouping target is grouped with the existing group of which a number of belonging secondary devices is small.

### ASPECT 17

A wireless communication method by which at least a single primary device and a plurality of secondary devices perform wireless communication via a single communication channel successively selected from a plurality of communication channels, the wireless communication method comprising: grouping a plurality of the secondary devices communicating wirelessly with the single primary device into two or more groups; determining, when the primary device communicates wirelessly with each of the plurality of secondary devices, communication quality of each communication channel for secondary devices belonging to at least one group that is grouped, and determining the communication channel to be used for wireless communication based on a determination result for the communication quality of each communication channel; and generating a common channel map by extracting a common communication channel that is a communication channel common to secondary devices belonging to the at least one group that is grouped, based on the communication channel to be used for wireless communication determined for secondary devices belonging to the at least one group, wherein the primary device and the secondary devices grouped into the at least one group perform wireless communication via the communication channel selected from the common communication channel indicated in the generated common channel map.

### ASPECT 18

A non-transitory computer-readable storage medium storing therein a wireless communication program by which at least a single primary device and a plurality of secondary devices perform wireless communication via a single communication channel successively selected from a plurality of communication channels, the wireless communication program causing at least a single processor to perform: grouping a plurality of the secondary devices communicating wirelessly with the single primary device into two or more groups; determining, when the primary device communicates wirelessly with each of the plurality of secondary devices, communication quality of each communication channel for secondary devices belonging to at least one group that is grouped, and determining the communication channel to be used for wireless communication based on a determination result for the communication quality of each communication channel; and generating a common channel map by extracting a common communication channel that is a communication channel common to secondary devices belonging to the at least one group that is grouped, based on the communication channel to be used for wireless communication determined for secondary devices belonging to the at least one group, wherein the primary device and the secondary devices grouped into the at least one group perform wireless communication via the communication channel selected from the common communication channel indicated in the generated common channel map.

What is claimed is:

1. A wireless communication system in which at least a single primary device and a plurality of secondary devices perform wireless communication via a single communication channel successively selected from a plurality of communication channels, the wireless communication system comprising:
a grouping unit that groups a plurality of the secondary devices communicating wirelessly with the single primary device into two or more groups;
a communication channel determination unit that, when the primary device communicates wirelessly with each of the plurality of secondary devices, determines communication quality of each communication channel for secondary devices belonging to at least one group that is grouped by the grouping unit, and determines the communication channel to be used for wireless communication based on a determination result for the communication quality of each communication channel; and
a generation unit that generates a common channel map by extracting a common communication channel that is a communication channel common to secondary devices belonging to the at least one group that is grouped by the grouping unit, based on the communication channel to be used for wireless communication determined by the communication channel determination unit for secondary devices belonging to the at least one group, wherein
the primary device and the secondary devices grouped into the at least one group perform wireless communication via the communication channel selected from the common communication channel indicated in the common channel map generated by the generation unit.

2. The wireless communication system according to claim 1, wherein:
the generation unit periodically updates the common channel map by repeating generation of the common channel map over time; and
the secondary device belonging to at least one other group other than the at least one group grouped by the grouping unit is excluded from a target for periodically updating the common channel map.

3. The wireless communication system according to claim 1, wherein:
the secondary devices respectively belonging to two or more groups grouped by the grouping unit are set as targets for determining the communication channel to be used for wireless communication by the communication channel determination unit; and
the communication channel determination unit determines the communication channel to be used for wireless communication using a determination criterion differing by group for the secondary devices respectively belonging to two or more groups

4. The wireless communication system according to claim 1, wherein:
each of the plurality of secondary devices is associated with any application to perform wireless communication with the primary device for execution of any application among a plurality of applications; and
the grouping unit groups the secondary device associated with each application for each application of the plurality of applications.

5. The wireless communication system according to claim 1, wherein:
the grouping unit groups the plurality of secondary device for each of a plurality of areas prescribed to include arrangement positions of the plurality of secondary devices performing wireless communication with the primary device in any area, with reference to a setup position of the primary device.

6. The wireless communication system according to claim 5, wherein:
the primary device is mounted in a vehicle; and
the plurality of areas is divided into a vehicle cabin area, a vehicle interior area, and a vehicle exterior area.

7. The wireless communication system according to claim 1, wherein:
the primary device has a plurality of antennas for wireless communication with the plurality of secondary devices;
the plurality of antennas are respectively set in differing positions; and
the grouping unit groups the plurality of secondary device for each of a plurality of areas prescribed to include arrangement positions of the plurality of secondary devices performing wireless communication with the primary device in any area, with reference to setup positions of the plurality of antennas.

8. The wireless communication system according to claim 1, wherein:
the plurality of secondary devices includes a fixed secondary device that is the secondary device set in a fixed position and a movable secondary device that is movable; and
the grouping unit groups the plurality of secondary devices such that the fixed secondary device and the movable secondary device are in differing groups.

9. The wireless communication system according to claim 8, wherein:
the movable secondary device grouped in a differing group from the fixed secondary device is excluded from a target for periodically updating the common channel map.

10. The wireless communication system according to claim 8, wherein:
the movable secondary device is an electronic apparatus carried by a user; and
when the movable secondary device and the primary device perform wireless communication, the movable secondary device functions as the primary device and the primary device functions as the secondary device.

11. The wireless communication system according to claim 1, wherein:
the plurality of secondary devices have identification information for identifying each secondary device and transmit the identification information during wireless communication with the primary device;
the primary device holds a list associating the identification information and information on belonging groups;
the grouping unit groups the plurality of secondary devices based on the list, based on the identification information transmitted wirelessly from each of the plurality of secondary devices to the primary device.

12. The wireless communication system according to claim 1, wherein:
the plurality of secondary devices have identification information for identifying each secondary device and group information indicating belonging groups, and transmits the identification information and the group information during wireless communication with the primary device; and
the grouping unit groups the plurality of secondary devices based on the identification information and the group information transmitted wirelessly from each of the plurality of secondary devices to the primary device.

13. The wireless communication system according to claim 1, wherein:
the grouping unit groups the plurality of secondary devices such that a number of common communication channels is equal to or greater than a predetermined threshold, based on the communication channel used to be used for wireless communication determined for each secondary device by the communication channel determination unit.

14. The wireless communication system according to claim 13, wherein:
the grouping unit determines the common communication channel when the secondary device serving as a grouping target is grouped with at least one existing group based on the communication channel to be used for wireless communication with the secondary device serving as a grouping target and the common communication channel of the at least one existing group, and when a number of determined common communication channels is equal to or greater than the predetermined threshold, the secondary device serving as the grouping target is grouped with the existing group, and when the number is less than the predetermined threshold, the secondary device serving as the grouping target is grouped into a new group.

15. The wireless communication system according to claim 13, wherein:
the grouping apparatus determines the common communication channel when the secondary device serving as a grouping target is grouped with at least one existing group based on the communication channel to be used for wireless communication with the secondary device serving as the grouping target and the common communication channel of the at least one existing group, and when a plurality of existing groups of which a number of determined common communication channels is equal to greater than the predetermined threshold are present, the secondary device serving as the grouping target is grouped into the existing group of which the number of determined common communication channels is largest.

16. The wireless communication system according to claim 13, wherein:
the grouping unit determines the common communication channel when the secondary device serving as a grouping target is grouped with at least one existing group based on the communication channel to be used for wireless communication with the secondary device serving as a grouping target and the common communication channel of the at least one existing group, and when a plurality of existing groups of which a number of determined common communication channels is equal to greater than the predetermined threshold are present and the numbers of determined common communication channels are same for the plurality of existing groups, the secondary device serving as the grouping target is grouped with the existing group of which a number of belonging secondary devices is small.

17. A wireless communication method by which at least a single primary device and a plurality of secondary devices perform wireless communication via a single communication channel successively selected from a plurality of communication channels, the wireless communication method comprising:
grouping a plurality of the secondary devices communicating wirelessly with the single primary device into two or more groups;
determining, when the primary device communicates wirelessly with each of the plurality of secondary devices, communication quality of each communication channel for secondary devices belonging to at least one group that is grouped, and determining the communication channel to be used for wireless communication based on a determination result for the communication quality of each communication channel; and
generating a common channel map by extracting a common communication channel that is a communication channel common to secondary devices belonging to the at least one group that is grouped, based on the communication channel to be used for wireless communication determined for secondary devices belonging to the at least one group, wherein
the primary device and the secondary devices grouped into the at least one group perform wireless communication via the communication channel selected from the common communication channel indicated in the generated common channel map.

18. A non-transitory computer-readable storage medium storing therein a wireless communication program by which at least a single primary device and a plurality of secondary devices perform wireless communication via a single communication channel successively selected from a plurality of communication channels, the wireless communication program causing at least a single processor to perform:
grouping a plurality of the secondary devices communicating wirelessly with the single primary device into two or more groups;
determining, when the primary device communicates wirelessly with each of the plurality of secondary devices, communication quality of each communication channel for secondary devices belonging to at least one group that is grouped, and determining the communication channel to be used for wireless communication based on a determination result for the communication quality of each communication channel; and
generating a common channel map by extracting a common communication channel that is a communication channel common to secondary devices belonging to the at least one group that is grouped, based on the communication channel to be used for wireless communication determined for secondary devices belonging to the at least one group, wherein
the primary device and the secondary devices grouped into the at least one group perform wireless communication via the communication channel selected from the common communication channel indicated in the generated common channel map.
